(19) United States
(12) Patent Application Publication
(10) Pub. No.: US 2023/0003653 A1
(43) Pub. Date: Jan. 5, 2023

(54) STIMULATED RAMAN SPECTROSCOPY FOR REAL-TIME, HIGH- RESOLUTION MOLECULAR ANALYSIS OF GASES IN HOLLOW CORE FIBRES

(71) Applicant: OPTIQGAIN LTD., Moshav Shahar (IL)

(72) Inventors: Ram ALON, Nir Banim (IL); Israel WOLF, Rehovot (IL)

(21) Appl. No.: 17/782,073

(22) PCT Filed: Dec. 9, 2020
(86) PCT No.: PCT/IL2020/051273

§ 371 Date: Jun. 2, 2022

Related U.S. Application Data
(60) Provisional application No. 62/946,444, filed on Dec. 11, 2019.

(51) Int. Cl. G01N 21/65; G01J 3/44; G01J 3/02; H01S 3/067; H01S 3/30

(52) U.S. Cl. CPC G01N 21/65; G01J 3/4412; G01J 3/0218; G01J 3/0208; H01S 3/06729; H01S 3/302; H01S 3/305; G01N 2021/655

(57) ABSTRACT

A stimulated Raman scattering (SRS) spectrometer for real-time, high-resolution molecular analysis of gases is based on two hollow-core fibres illuminated by a single high-power, short-pulse laser pump. The first fibre is prefilled with high-concentration target gases. Interaction of each target gas inside the first fibre, with the laser pump, generates Raman signals corresponding to the target gases. The combined beam of the Raman signals and the pump laser beam is directed into the second fibre containing the measured target gases. Interaction of each target gas with the combined beam generates the Stimulated Raman Growth (SRG), i.e., amplification of the Raman signal, which is proportional to the corresponding target gas concentration. A receiver subsystem receives the beam from the second fibre, spectrally separates it to wavelengths corresponding to each target gas, extracts the SRG value corresponding to each target gas and calculates the concentration of each target gas.

### TECHNICAL FIELD

The present application relates to stimulated Raman spectroscopy for high-resolution, real-time, and on-site molecular analysis of gases in laboratories and industrial environment.

### BACKGROUND

Manufacturing industries such as energy, oil and gas, chemicals, pharmaceuticals and semiconductors generate trillions of dollars in revenue. They are characterized by complex processes, high capital and operating costs, including various equipment, raw materials, energy, catalysts, and relatively low profitability. In some respects, modern processes are ineffective, inflexible, polluting, and far from optimal. Improving the efficiency of these industrial processes can have a significant impact on pollutant emissions, energy and material efficiency, profit margins and financial benefits. Inadequate process monitoring technologies, such as chromatography-based sensors or spectral instruments, cannot meet the industry requirements for a combination of high accuracy and real-time process control.

One of many examples of industrial processes in need of improvement and optimisation are the world's power plants using natural gas as an energy source. In today's global gas market, consumers receive gas from several sources, such as natural gas fields, shale gas production, liquefied natural gas and biogas. Real-time monitoring of gas composition (input and output gas) improves turbine control and can improve performance, protect the environment and prevent turbine damage. Gas turbines can operate with a very wide range of energy sources, but unpredictable changes in gas composition can damage the turbines. In petrochemical processes, the purity of the gases entering the reactors is critical to the quality of the final product. A small number of pollutants can negatively affect the entire batch, and therefore real-time monitoring can allow better control of the incoming gases and prevent such negative effects.

Modern gas chromatographs are almost universally used to measure natural gas composition and its heating value. Ward et al (in “Real time monitoring of a biogas digester with gas chromatography, near-infrared spectroscopy, and membrane-inlet mass spectrometry”, Bioresource Technology 102, 2011, pp. 4098-4103) employed four methods for monitoring an anaerobic digestion process at a pilot scale. Methods used to measure gases include membrane inlet mass spectrometry (MIMS) and micro-gas chromatography (μ-GC). The μ-GC method requires little maintenance, while the MIMS method requires frequent cleaning and background measurements. In addition, the μ-GC method measures hydrogen, methane, nitrogen, oxygen and hydrogen sulphide very accurately, while the MIMS accurately measures methane, carbon dioxide and hydrogen sulphide, reduced organic sulphur compounds and p-cresol, also in headspace. However, while accurate, these methods are very slow.

In an attempt to overcome the aforementioned problem of relatively slow measurements with a gas chromatograph, G. E. Fodor (1996) under the contract to U.S. Army TARDEC Mobility Technology Centre in Belvoir, Va. (Contract No. DAAK70-92-C-0059) developed the use of mid-band Fourier-Transform Infrared spectroscopy (FTIR) as a fast and reasonably reliable laboratory or field method for assessing the composition and properties of natural gas, and to demonstrate the feasibility of using FTIR as an on-line natural gas analyser. A very fast experimental FTIR protocol has been developed for the simultaneous determination of methane, ethane, propane and butane in nitrogen from real-time FTIR spectra. This method is based on correlations found between several known gas compositions and their FTIR spectra. However, conventional FTIR instruments used for gas detection and analysis in industry are expensive, require some experienced operators, cannot be used directly on gas lines, cannot respond quickly enough for monitoring purposes, and have low sensitivity.

Spontaneous Raman spectroscopy has been used in industry for over twenty years. Most analytes, including gases, have a unique “Raman fingerprint” that can be used to specifically and very accurately detect and measure analytes and their concentrations. Although it is a powerful tool for chemical and biochemical analysis, providing specific vibrational signatures of chemical bonds, analysers based on spontaneous Raman spectroscopy are nevertheless hampered by long acquisition times and often low sensitivity, which requires the use of powerful lasers. In fact, this is a trade-off between real-time measurement and resolution. Its effectiveness is even more limited when testing low concentration target samples.

Stimulated Raman scattering belongs to a family of spectroscopic methods based on the phenomenon of light scattering. While the history of this technique parallels that of laser light sources, recent advances have spurred a resurgence in its use and development that has spanned across scientific fields and spatial scales. SRS is a nonlinear optical technique that tests the same vibrational modes of molecules that are observed in spontaneous Raman scattering of light. However, although spontaneous Raman scattering of light is an incoherent method, SRS is a coherent process, and this fact offers several advantages over traditional Raman scattering methods.

Raman amplification is expected to follow the SRS mechanism. In general, it is expected that above a certain threshold for pump photons, as soon as Raman photons are generated at an intensity above the system loses, the stimulated Raman scattering will be amplified according to the stimulated Raman scattering related equations:

$$\frac{{dI}_{R}}{dz} = {g}_{R} {I}_{p} {I}_{R} - {a}_{R} {I}_{R} \\ \frac{{dI}_{p}}{dz} = - \frac{{w}_{p}}{{w}_{R}} {g}_{R} {I}_{p} {I}_{R} - {a}_{p} {I}_{p}$$

where I_{R} is the intensity of the Raman signal of a specific transition, Iₚ is the pump intensity, w_{R} and wₚ are the angular frequencies of the Raman and pump beams, respectively, a_{R} and aₚ are the losses of the Raman and pump beams, respectively, g_{R} is the Raman gain coefficient which is transition- and wavelength-dependent, z is the coordinate along the fibre axis.

In the present application, the term “Raman” or “Raman signal” refers to Stokes as well as anti-Stokes Raman lines in the spectrum. Throughout the present specification, this term is used interchangeably with the term “Stokes and anti-Stokes signals”.

It is expected that g_{R} will depend on the wavelength, temperature, pressure (concentration) and molecule-specific Raman cross-section. In the case of self-stimulated Raman amplification, I_{R} is initially zero and only pump laser is coupled to the fiber to start with. As Raman photons are generated spontaneously, they are amplified along the fiber in accordance to the stimulated Raman scattering mechanism.

Modern solutions to control the relatively low signal-to-noise ratio and low resolution of the stimulated Raman scattering systems require high peak power, narrow spectral width, very stable and accurate low-noise optical components such as photodiodes and laser sources, together with high-resolution, low-noise analogue-to-digital converters. However, these components are expensive and, in many cases, need to be made to order. Moreover, the system architecture is too complex, cumbersome, relatively fragile, and difficult to align or maintain alignment. It also cannot be used outdoors. Alternatively, there are various commercially available lasers that are less accurate, inherently unstable, have a high background, and are subject to wavelength drift. The development of a method for using such unstable lasers in Raman spectroscopy can significantly reduce the cost and size of the device, as well as increase the reliability of the system. However, for this reason, and despite the aforementioned advantages of stimulated Raman scattering over other methods used in molecular analysis, the use of stimulated Raman scattering has not yet been implemented in the industry.

As mentioned above, the stimulated Raman scattering spectroscopic instruments are currently used only in the academic institutions. However, it has been a long-felt need to create a relatively small in size, robust and capable of operating in industrial environments, device for on-line, real-time, high-resolution monitoring of gases on a molecular level in industrial processes. A robust, real-time, high-resolution industrial molecular analyser directly sampling tens of intermittent stages of the industrial plant processes, taking into account safety precautions in various aggressive, hazardous and explosive environments, whilst performing the completely automatic analysis with relatively low maintenance cost (no moving parts, no consumables and high durability) is highly desirable. Such device disclosed in the present application, used for real-time control and massive data collection of industrial processes, through real-time response and high-resolution monitoring of the target molecules composition, is suitable for on-field, industrial conditions in a wide range of temperatures and monitoring conditions, including corrosive environments, high noise and vibrations.

### SUMMARY

The present invention describes a stimulated Raman scattering (SRS) spectrometer for real-time, high-resolution molecular analysis of one or more target gases in a gas sample, based on two hollow-core optical fibres (420, 450) illuminated by a single high-power, short-pulse laser pump (15). The first fibre (420) is prefilled with high concentration target gases. Interaction of each target gas with the pump laser beam generates the corresponding Raman lines based on self-stimulated Raman scattering (SSRS) phenomenon inside the first fibre (420). The combined beam of the amplified SSRS signals propagating with the pump laser beam exited from the first fibre (420) is directed into the second fibre (450) containing the gas sample to be measured. Interaction of each target gas from the gas sample with the combined beam generates the stimulated Raman scattering (SRS) phenomenon for this target gas, thereby amplifying the corresponding Raman line and increasing intensity of the Stimulated Raman Growth (SRG), which is proportional to the corresponded target gas concentration. A receiver subsystem (30) receives the beam from the second fibre (420), preforms spectral separation to a set of selected narrow wavelength beams corresponding to each target gas, extract the SRG signal that corresponds to each target gas and calculates the concentration of each target gas in the gas sample form the extracted SRG value.

In one embodiment, the SRS spectrometer of the present invention comprises:
A. a laser source (10) comprising a single high-power laser (15), which is configured to generate a high-power, short-pulse laser beam (pump), and a set of optical manipulators (403), which are designed to clean the spectrum of the single high-power laser (15), to set the final laser power and to direct said laser beam (pump) to a first optical interface (410) of a first hollow-core optical fibre (420);
B. a molecular gas analysis subsystem (40) comprising:
   (a) the first optical interface (410) configured to couple said laser beam into the first hollow-core optical fibre (420) and to enable prefilling said first hollow-core optical fibre (420) with one or more static gases in high concentration, said gases are the same gases as those being analysed;
   (b) the first hollow-core optical fibre (420), which is prefilled with said static gases in high concentration, said first fibre (420) is a “signal generator” fibre suitable for generating and emitting a self-stimulated Raman signal, which co-propagates with said laser beam (pump signal) as a combined light beam (comb signal) along the first fibre (420) to a second optical interface (430) of the first fibre (420);
   (c) the second optical interface (430) configured to perform spectral filtration of said combined light beam, to sample said combined light beam for intensity reference and to direct the intensity reference signal to a receiver subsystem (30), to direct said combined light beam to a second hollow-core optical fibre (450), to vent the first fibre (420) for maintenance purposes, and to provide the gas sample for the molecular analysis in the second fibre (450);
   (d) the second hollow-core optical fibre (450), which contains the gas sample, said second fibre (450) is a “sample analysis” fibre suitable for receiving said combined light beam from the second optical interface (430) and transferring said combined light beam along its hollow core, wherein said combined light beam interacts with molecules of the target gases in the gas sample inside the hollow core of the second fibre (450), thus amplifying the Raman signals in the combined light beam by stimulated Raman scattering on said molecules for each gas being analysed in the gas sample, said amplification is performed with the specific comb containing the pump signal (laser beam) and said Raman signals in the combined light beam generated in the first fibre (420), and results in amplifying the intensity of the corresponding Raman signals (resulting in stimulated Raman gain); and
   (e) a third optical interface (460) configured to receive the comb of said amplified Raman signals from the second fibre (450), to direct the amplified Raman signals to the receiver subsystem (30) via an optical fibre or through free space optics for spectral analysis, to block the pump signal (laser beam), and to vent the second fibre (450); and
C. the receiver subsystem (30) designed to receive the amplified Raman signals from the third optical interface (460), to receive the intensity reference signals from the second optical interface (430), to spectrally separate each of said received signals (the Raman signals and the reference signals) to its individual Raman lines corresponding to the target gases, to convert optical signals to electronic signals, to extract the stimulated Raman gain (SRG) at each wavelength by comparing the intensity of the reference signal to the intensity of the amplified Raman signal for each wavelength, and to calculate each gas concentration out of this SRG comparison, said receiver subsystem (30) comprises:
   (a) an optical frontend (32) configured to perform said spectral separation by selecting a single wavelength corresponding to a wavelength of a certain Raman line, and to control the intensity of the optical signals prior to their conversion to the electronic signals using photodiodes;
   (b) at least one optical-to-electronic conversion device (326, 327) configured to capture the laser pulses (optical signals) and convert the optical signals to the electronic signals;
   (c) an analogue frontend (34) configured to amplify the SRG signal and to generate a timing trigger to a digital receiver (36);
   (d) a digital receiver (36) configured to convert analogue signals to digital samples, to perform a time-gated acquisition for improving signal-to-noise ratio, and to store blocks of repeated SRG samples of a single gas; and
   (e) an electronic processing unit (20) configured to read the blocks of the SRG samples, perform further improvement of the signal-to-noise ratio of said SRG signal using digital signal processing algorithms, extract the SRG at each said wavelength and calculate concentration of each said gas in the sample.

In some embodiments, the gas sample is a flow of one or more gases being analysed, flowing through the second hollow-core optical fibre. In other embodiments, the gas sample is one or more static gases being analysed, introduced into the second hollow-core optical fibre.

In a further embodiment, the high-power laser (15) comprises:
(a) a laser driver and controller (11) designed to provide the electronic power to the high-power laser (15) and control a variety of parameters, such as current and temperature;
(b) a high-power laser source (12) suitable for generating high-power laser beam and for pumping a diode-pumped solid-state (DPSS) laser (401);
(c) the DPSS laser (401) suitable for converting the high-power laser beam generated by the high-power laser source (12) to high-power pulses; and
(d) an optional second harmonic generator (SHG) (402) configured to receive the high-power short pulses from the DPSS laser (401) and double the frequency of these pulses, thereby generating the high-power short-pulse laser beam at half the wavelength of said beam.

In a typical industrial process, a testing point is usually located in extreme conditions, such as hazardous and explosive environments, which require special safety precautions. Laser sources require stable and controlled condition in order to generate high quality laser beams. Generating laser beams in extreme conditions is generally possible, but very expensive. Therefore, one of the possible solutions to this problem is to place the laser source (10) together with the receiver subsystem (30) far from the testing site in a safe and protected environment, for example, in laboratory or in a control room.

In one embodiment, the laser source (10), molecular gas analysis subsystem (40) and receiver subsystem (30) are installed in the same single enclosure, frame or room, in a protected environment. In another embodiment, the laser source (10) and receiver subsystem (30) are installed in the same single enclosure, frame or room, in a protected environment, and the molecular gas analysis subsystem (40) is placed separately in close proximity to the source of the gas sample. In some embodiments, the single high-power laser (15) is installed in a protected environment, and the high-power laser pulses (pump) are delivered to the molecular gas analysis subsystem (40) via high-power fibre optics.

In yet further embodiment, the SRS spectrometer of the present invention further comprises an optical fibre (50) connecting the laser source (10) with the molecular gas analysis subsystem (40) and suitable for transmitting said high-power laser pulses (pump) from the optical manipulators (403) into the first optical interface (410) of the molecular gas analysis subsystem (40), said optical manipulators (403) are configured to couple said single high-power laser (15) to said optical fibre (50).

In a particular embodiment, the laser driver and controller (11) and the high-power laser source (12) are installed in the same single enclosure, frame or room together with the receiver subsystem (30), in a protected environment, and the DPSS laser (401) and the optional (SHG) (402) together with the molecular gas analysis subsystem (40) are installed in close proximity to source of the gas sample. In a specific embodiment, the DPSS laser (401) is a passive Q-switch. In a further specific embodiment, the molecular gas analysis subsystem (40) is a purely optical, passive subsystem that does not contain any electronic components.

The SRS spectrometer of the present invention directly irradiates the sample with a single laser beam (pump), and the analysis of the emitted laser radiation provides on-site real-time detection and concentration measurements of a target gas in the gas sample. No sample preparation is needed. The molecular gas analysis subsystem (40) for industrial gas flows is therefore designed to be located close to the testing point connected to the gas stream via a small pipe, making the sensing suitable for various industrial environments, such as high temperatures, explosive materials, corrosive conditions, high noise, and vibrations, and is capable of measuring gas streams under high pressures and high temperatures.

The SRS spectrometer of the present invention can be used to measure gas composition in all segments of the manufacturing industry. It provides the molecular composition of the gases of interest in their mixture with extremely high resolution up to 1 ppm in no more than 5 seconds. One of many industrial applications of the SRS spectrometer of the present invention is to monitor in real time the composition of natural gas and biogas during their production (gas cleaning) and transport chains (gas custody transfer). A specific example is the input flow measurements (natural gas) and output (exhaust, flue gases) in gas turbine power plants, which allows on-line detection of changes in gas composition, calibration and optimisations of the turbine combustion, taking into account the changes in gas composition at the turbine inlet, which prevents damage to the turbine due to sudden changes in gas composition and increases the efficiency of power generation.

Other non-limiting examples are monitoring various gases in the hydrogen production process, monitoring the composition of gases in petrochemical processes (in particular the production of olefins), continuous monitoring of flue gas emissions (CEMS) in industrial plants and vessels for environment protection, high-resolution gas monitoring in various processes in the semiconductor industry. By setting the gas composition in the first hollow-core fibre (420), the SRS spectrometer of the present invention provides versatility and simple configuration for use in many other applications which are not mentioned above.

Various embodiments may allow various benefits and may be used in conjunction with various applications. The details of one or more embodiments are set forth in the accompanying figures and the description below. Other features, objects and advantages of the described techniques will be apparent from the description and drawings and from the claims.

### BRIEF DESCRIPTION OF THE DRAWINGS

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1 schematically shows the stimulated Raman scattering (SRS) spectrometer of the present invention according to a first embodiment.

FIG. 2 illustrates the self-stimulated Raman signal generation in hollow core optical fibres.

FIG. 3 illustrates the concept behind the stimulated Raman scattering (SRS) spectrometer based on a single laser source and two hollow-core optical fibres.

FIG. 4 schematically shows the laser source (10) and the molecular gas analysis subsystem (40) of the SRS spectrometer of the present invention according to a first embodiment.

FIG. 4a schematically shows the expanded view of the first interface (410) of the molecular gas analysis subsystem (40) of the SRS spectrometer of the present invention.

FIG. 4b schematically shows the expanded view of the second optical interface (430) of the molecular gas analysis subsystem (40) of the SRS spectrometer of the present invention.

FIG. 4c schematically shows the expanded view of the third optical interface (460) of the molecular gas analysis subsystem (40) of the SRS spectrometer of the present invention.

FIG. 5 illustrates the concept behind the amplification of the Raman signals entering the receiver subsystem (30) of the SRS spectrometer of the present invention.

FIG. 6 schematically shows the receiver subsystem (30) of the SRS spectrometer of the present invention.

FIG. 7 schematically shows the gas analysis subsystem (40) of the SRS spectrometer of the present invention according to a second embodiment.

FIG. 8 schematically shows the SRS spectrometer of the present invention according to a third embodiment.

FIG. 9 schematically shows the SRS spectrometer of the present invention according to a fourth embodiment.

FIG. 10 schematically shows the SRS spectrometer of the present invention according to a fifth embodiment.

### DETAILED DESCRIPTION

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising x and z” should not be limited to devices consisting only of components x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached to”, “connected to”, “coupled with”, “contacting”, etc., another element, it can be directly on, attached to, connected to, coupled with or contacting the other element or intervening elements may also be present. In contrast, when an element is referred to as being, for example, “directly on”, “directly attached to”, “directly connected to”, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

The gas sample containing the target gas molecules being analysed or quantified may be a single gas or a mixture of gases, for example, different gases evolved in industrial processes over time. The “gas sample” may also be herein referred to as a “test sample” or “target analyte sample” without any intent at distinguishing between these terms. The gases being tested or analysed may also be herein referred to as “analytes”, “target analytes” or “target molecules”. In one embodiment, the gas sample is a flow of one or more gases being analysed, flowing through the second hollow core optical fibre. In another embodiment, the gas sample is one or more static gases being analysed, introduced into the second hollow core optical fibre.

Unless otherwise defined, the term “Raman signal” or “Raman line” should be understood as the term combining both Stokes and anti-Stokes signals or lines in Raman spectra, respectively. The terms “Stokes signal” and “anti-Stokes” are used interchangeably in the present application and should be also understood as terms for a laser signal that matches the Raman signal, which (unless otherwise defined) can be either a Stokes signal or anti-Stokes signal, or a combination of both, dependent on a specific application.

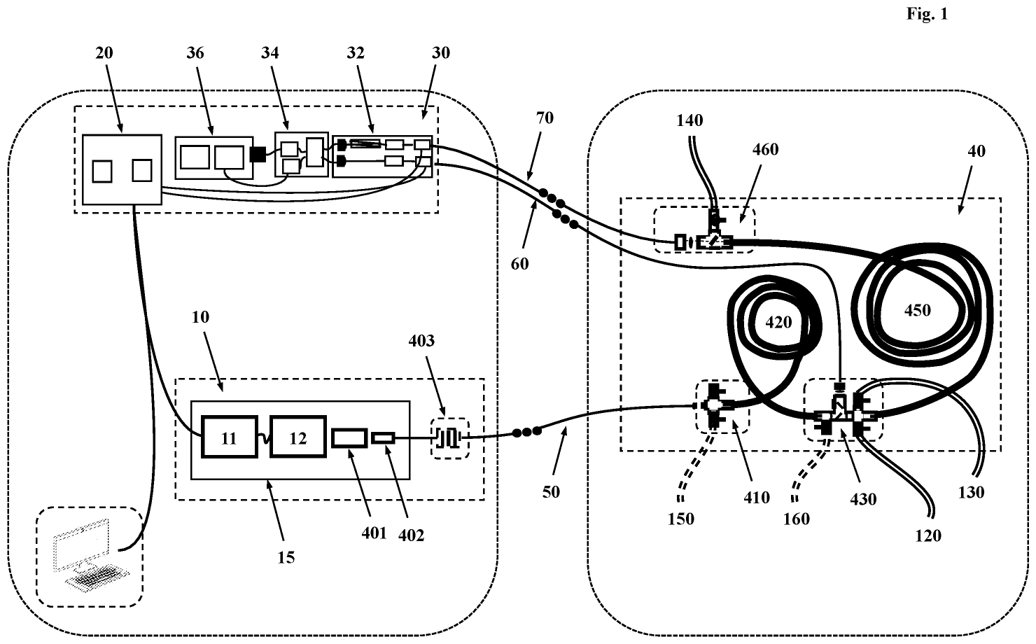

The present invention describes a stimulated Raman scattering (SRS) spectrometer for real-time high-resolution molecular analysis of one or more gases in a gas sample. The SRS spectrometer is designed to measure concentration of said one or more gases in the gas sample and based on a single laser source and two hollow-core optical fibres. Reference is now made to FIG. 1 showing the layout of the SRS spectrometer of the present invention according to a first embodiment, where the SRS spectrometer comprises:
A. a laser source (10) comprising a single high-power laser (15), which is configured to generate a high-power and short-pulse laser beam (pump), and a set of optical manipulators (403), which are designed to clean the laser (15), to set the final laser power and to couple the laser (15) to an optical fibre (50) suitable for transmitting said laser beam (pump) into a first optical interface (410) of a first hollow-core optical fibre (420);
B. a molecular gas analysis subsystem (40) comprising:
   (a) the first optical interface (410) configured to couple said laser beam into the first hollow-core optical fibre (420) and to enable prefilling said first hollow-core optical fibre (420) with one or more static gases in high concentration, said gases are the same gases as those being analysed;
   (b) the first hollow-core optical fibre (420), which is prefilled with said static gases in high concentration, said first fibre (420) is a “signal generator” fibre suitable for generating and emitting a self-stimulated Raman signal, which co-propagates with said laser beam (pump signal) as a combined light beam (comb signal) along the first fibre (420) to a second optical interface (430) of the first fibre (420);
   (c) the second optical interface (430) configured to perform spectral filtration of said combined light beam, to sample said combined light beam for intensity reference and to direct the intensity reference signal to a receiver subsystem (30), to direct said combined light beam to a second hollow-core optical fibre (450), to vent the first fibre (420) for maintenance purposes, and to provide the gas sample for the molecular analysis in the second fibre (450);
   (d) the second hollow-core optical fibre (450), which contains the gas sample, said second fibre (450) is a “sample analysis” fibre suitable for receiving said combined light beam from the second optical interface (430) and transferring said combined light beam along its hollow core, wherein said combined light beam interacts with molecules of the target gases in the gas sample inside the hollow core of the second fibre (450), thus amplifying the Raman signals in the combined light beam by stimulated Raman scattering on said molecules for each gas being analysed in the gas sample, said amplification is performed with the specific comb containing the pump signal (laser beam) and said Raman signals in the combined light beam generated in the first fibre (420), and results in amplifying the intensity of the corresponding Raman signals (resulting in stimulated Raman gain); and
   (e) a third optical interface (460) configured to receive the comb of said amplified Raman signals from the second fibre (450), to direct the amplified Raman signals to the receiver subsystem (30) via an optical fibre or through free space optics for spectral analysis, to block the pump signal (laser beam), and to vent the second fibre (450); and
C. the receiver subsystem (30) designed to receive the amplified Raman signals from the third optical interface (460), to receive the intensity reference signals from the second optical interface (430), to spectrally separate each of said received signals (the Raman signals and the reference signals) to its individual Raman lines corresponding to the target gases, to convert optical signals to electronic signals, to extract the stimulated Raman gain (SRG) at each wavelength by comparing the intensity of the reference signal to the intensity of the amplified Raman signal for each wavelength, and to calculate each gas concentration out of this SRG comparison, said receiver subsystem (30) comprises:
   (a) an optical frontend (32) configured to perform said spectral separation by selecting a single wavelength corresponding to a wavelength of a certain Raman line, and to control the intensity of the optical signals prior to their conversion to the electronic signals using photodiodes;
   (b) at least one optical-to-electronic conversion device (326, 327) configured to convert the optical signals to the electronic signals;
   (c) an analogue frontend (34) configured to amplify the SRG signal and to generate a timing trigger to a digital receiver (36);
   (d) a digital receiver (36) configured to convert analogue signals to digital samples, to perform a time-gated acquisition for improving signal-to-noise ratio, and to store blocks of repeated SRG samples of a single gas; and
   (e) an electronic processing unit (20) configured to read the blocks of the SRG samples, perform further improvement of the signal-to-noise ratio of said SRG signal, using digital signal processing algorithms, and calculate concentration of each said gas in the sample.

Additional elements can be included or placed in connection with the spectrometer of the present invention. These include, but are not limited to, the power supply, temperature control unit, and/or pressure control unit. The relationship between these blocks and the elements and subsystems described above can be easily combined by those skilled in the art, so no further details are given. Output and/or control devices such as displays, printers, alarms or controllers can be in electronic communication with an electronic processing unit (20). This information can provide real-time results, among other things, indicating that the stimulated Raman scattering (SRS) spectrometer of the present invention is operating under less-than-optimal conditions. Analysis of the received information can be used to change, modify or reconfigure the parameters of the operating system to which it is connected. Such a modification may, without intending to limit the present invention, provide feedback to ensure operation within the required limits, safety shutdown, limit alerts or warnings of the presence of undesirable or unexpected materials and/or materials in undesirable quantities in gas samples. The integrated operating system controller can then shut down the operating system or otherwise indicate to the user that a manual shutdown or other corrective action is required.

As defined above, the SRS spectrometer of the present invention is essentially based on a combination of two hollow-core optical fibres (420, 450). The first hollow-core optical fibre (420) is used to generate the appropriate Raman signal (Stokes or anti-Stokes) and is pre-filled with high concentration target gases. A high-power short-pulse pumping laser (15) is coupled with this first fibre (420), in which the interaction of each target gas with the pumping laser generates the corresponding Raman lines (Stokes or anti-Stokes) based on self-stimulated Raman scattering (SSRS) phenomena. The laser beam at the exit from the first fibre (420) contains a signal from a high-power pump laser and the corresponding Raman lines and actually constitutes a combined beam of amplified self-stimulated Raman signals propagating with the pump laser beam. This beam, also called a “wavelength comb”, is coupled with the second hollow-core optical fibre through an interface (second interface) that allows the laser and gas to enter the second hollow-core fibre.

Along the second hollow-core fibre (450), the SRS phenomenon occurs where each target gas interacts with a common pump and with the appropriate Raman signal, thereby amplifying the corresponding Raman line. The accumulated gain of the amplified Raman signals at the end of the second fibre (450) correlates with the concentration of each target gas. The system is calibrated accordingly. At the output of the second fibre (450), the pump signal is filtered and the beam containing only Raman signals is sent to the receiver subsystem (30) for spectral analysis. Comparison of the Raman signal intensities at the input (reference signals) and the amplified Raman signals at the output of the second fibre (450) allows the measurement of the target gas concentrations at very low concentrations (below 100 ppm).

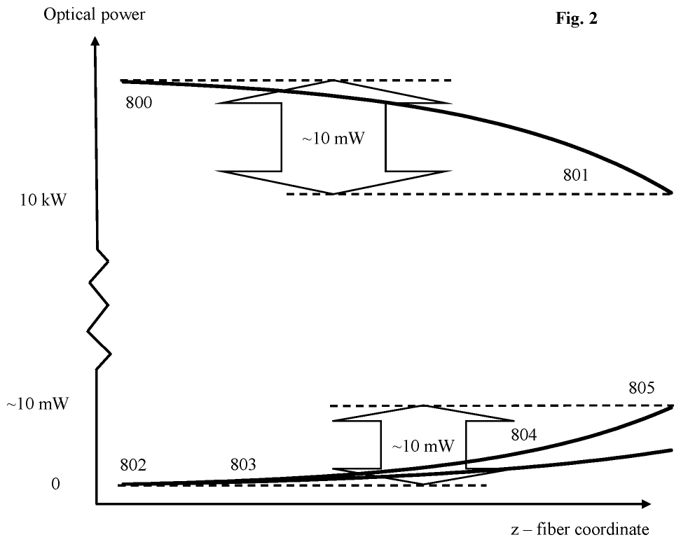

Reference is now made to FIG. 2 illustrating the amplification of the self-stimulated Raman scattering. High-power pump pulse propagates through a hollow-core optical fibre and interacts with gas molecules filling the hollow core optical fibre (800). Because the pulse is very high-power, its intensity remains nearly constant throughout the fibre (for all molecular interactions), and pump laser losses are expected to be on the order of 1-100 W of the initial pulse of 4-20 kW peak power (801). At the entrance to the hollow-core optical fibre, the Raman signal is zero (802). The short-term interaction of the pump laser beam with gas molecules generates a spontaneous Raman signal (803). If the pump power exceeds a certain threshold, the generated Raman signal exceeds its losses in the hollow-core optical fibre. As a result, SRS becomes the dominant phenomenon, and the Raman signal is nonlinearly amplified when the laser light propagates in the hollow-core optical fibre (804). At the exit from this hollow-core optical fibre, the Raman signal is several orders of magnitude higher than the spontaneous Raman signal (805). In addition to absorption by gas molecules, the fibre itself can be regarded as a significant source of losses, depending on its spectral transmission curve and the nature of mode propagation along the fibre. Ideally, all photons propagate in the main central mode and therefore interact with the gas. In practice, some photons travel in different modes and their contribution to the Raman signal is unknown.

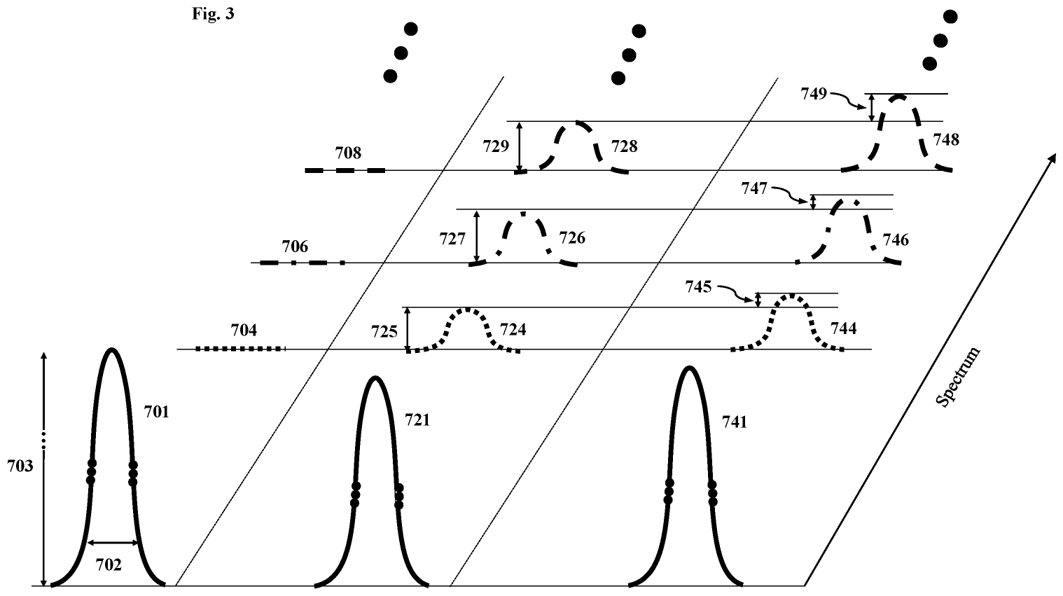

Reference is now made to FIG. 3 that illustrates the spectroscopical concept behind the stimulated Raman scattering (SRS) spectrometer of the present invention based on a single laser (15) and two hollow-core optical fibres (420 and 450). A conventional SRS spectroscopy implementation uses two lasers sources with a spectral distance corresponding to a particular Raman transition in one of the measured gases of interest. The SRS phenomenon is carried out by the same gas only so that the SRS signal correlates with the concentration of this gas. The present invention describes a general-purpose on-site spectrometer or molecular analyser capable of rapidly generating a high-resolution Raman spectrum of a gas sample, which is a target gas or a mixture of gases in about 1-5 seconds based on applying combination of two Stimulated Raman techniques: Self-Stimulated Raman Scattering in the first fibre (420) and Stimulated Raman Scattering in the second fibre (450).

The present invention performs a parallel, simultaneous SRS process for multiple gases of interest. The gas mixture in the first hollow-core fibre (420) constitutes a composition of target gases with high concentration and high pressure. It is illuminated by one pump laser (15) (common for all gases) with a sequence of short pulses (701, 721, 741) having high-peak power (703), which is typically between 5 kW to 30 kW, and a pulse width (702) of nanosecond or sub-nanosecond duration. There are no Raman signals (704, 706, 708) at the entrance to the first fibre (420), and the only signals there are pump signals (701, 721, 741). As these pulses (pump signals) propagate through the first fibre (420), several specific Raman signals (including Stokes and anti-Stokes) appear simultaneously. Concentration and pressure of the prefilled gases in the first fibre (420) are sufficient to generate the self-stimulated Raman scattering (SSRS) phenomenon (as described above).

There are several Raman signals (724, 726, 748) appearing at the exit of the first fibre (420), wherein each signal corresponds to a specific gas in the gas mixture. The SSRS phenomenon occurs simultaneously for all gases in the mixture, wherein for each particular gas in the mixture, the signal intensity or amplitude (725, 727, 729) corresponds to the pump power, the particular gas concentration and this particular gas Raman cross-section.

Thus, the combined beam at the exit from the first fibre (420) contains the pump signal and the generated self-stimulated Raman signal. This combined beam also defined as a “comb” signal is directed into the second hollow-core optical fibre (450). In most cases, the concentration of the target gases in the gas sample is insufficient to enable the SSRS phenomenon. However, the comb laser signal containing the pair of laser signals entering the second fibre (450) overcomes this insufficiency. Since the gases prefilled in the first fibre (420) are essentially the same gases as the target gases in the gas sample in the second fibre (450), the Raman signals in the comb signal correspond to each of these target gases and enable the stimulated Raman scattering phenomenon on the molecules of these gases inside the second fibre (450).

The combined beam propagates through the second fibre (450), interacts with the molecules of the target gases in the gas sample and generates the SRS phenomenon, where energy from the pump signal is transferred to the Raman signals. At the exit from the second fibre (450), the amplitude or intensity of the Raman signals (744, 746, 748) is therefore significantly increased, where this increase is actually the SRG (stimulated Raman gain) for each gas (745, 747, 749). These SRGs are correlated to the target gases concentration (the required measured parameter), as well as to the pump laser power, the Raman signal power at the entrance to the first fibre (420), the specific gas Raman cross-section and other system parameters, such as the length of the second fibre (450), gas pressure, temperature etc. All these system parameters can be measured and used to extract the specific gas concentration form the specific gas SRG value.

To achieve a high resolution of spectral measurements of target gases, spectrometers based on the SSRS phenomenon must use high-peak power nano- or picosecond lasers. Relatively small diameter of the hollow core of an optical fibre in these spectrometers provides illumination of more than 10 MW/cm², which is necessary for the SSRS phenomenon. The length of the hollow-core optical fibre must exceed a minimum length (usually several meters) in order to provide the amplification described in the present invention.

The hollow core fibres of the present invention have a specific spectral transmission curve. In general, hollow core optical fibres are a specific type of glass fibres that, unlike conventional optical fibres, allow the guidance of an optical wave in the hollow region of the fibre. Their most promising advantages are, therefore, directly-linked to the absence of glass material in the fibre core, which, in principle, may be expected to imply, not only lower nonlinearity and dispersion, but also lower attenuation. In other words, hollow-core fibres are optical fibres which guides light essentially within a hollow region, so that only a minor portion of the optical power propagates in the solid fibre material (typically a glass). The hollow core can be filled with gas or enable gas to flow through it. The hollow region of the fibre is relatively small (approximately 50 μm in diameter), the gas is located (static or flow through) in that region. Such confined environment is optimal for the quantum-optics interaction (which is SRS in the present case) between the gas and the laser, as the laser intensity is very high across the full length of the fibre. SRS amplification is exponential with the interaction length and permitted only above high level of light intensity and high gas concentration.

A specific example of the hollow-core fibre architecture is a Photonic-Crystal Hollow-Core Fibre (PCHCF) containing a pattern of silica rings (with circular or elliptical cross-section) around the hollow core. This structure confines light in hollow cores with confinement characteristics, which are not possible in conventional optical fibres, because in the conventional fibres, the refractive index of the fibre core has to be higher than that of the surrounding cladding material, and there is no way of obtaining a refractive index of glass below that of air or vacuum, at least in the optical spectral region. By tuning the structure of the silica rings, it is possible to control the spectral transmission curve of the fibre and consequently, suppress non-desired wavelengths.

It is of ultimate importance for the SRS spectrometer of the present invention to match the transmission curve of the fibre to the wavelength of the pump laser and to the target Raman signals. This will amplify only the target Raman signals and suppress unwanted scattering signals at other wavelengths. For example, in the case of using a hollow-core optical fibre with good transmission in the range of 500-700 nm, the use of pumping at a wavelength of 532 nm makes it possible to amplify the Stokes signals of all hydrocarbon gases while simultaneously suppressing anti-Stokes signals, which are characteristic for these gases. On the contrary, the use of a hollow core fibre with good transmission at a wavelength of 700-1100 nm and a pump laser at a wavelength of 1064 nm makes it possible to amplify anti-Stokes gases and suppress Stokes signals.

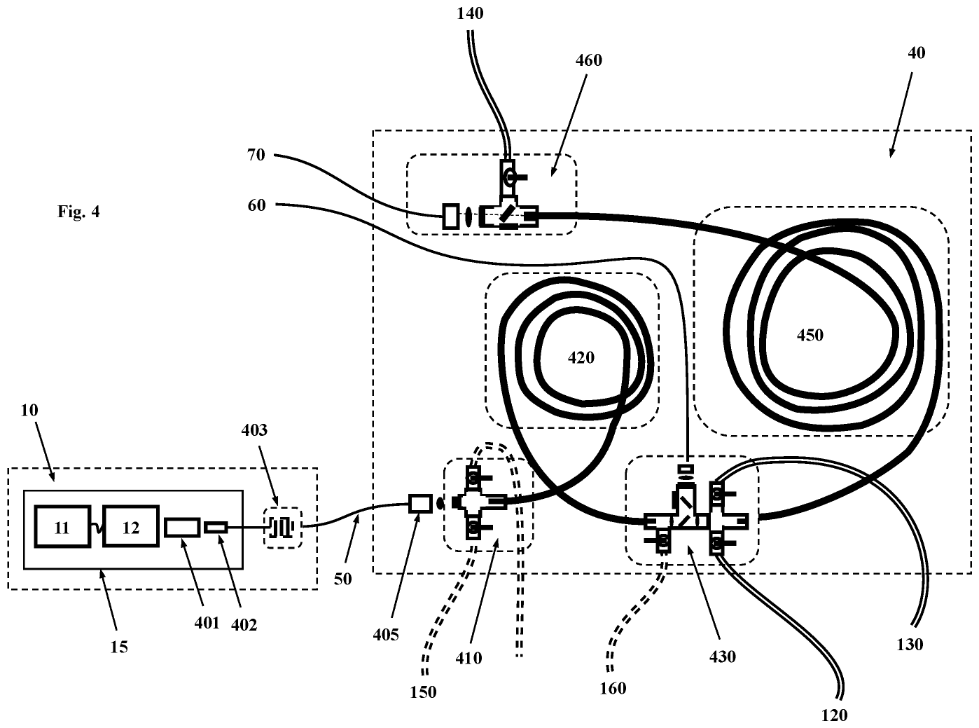

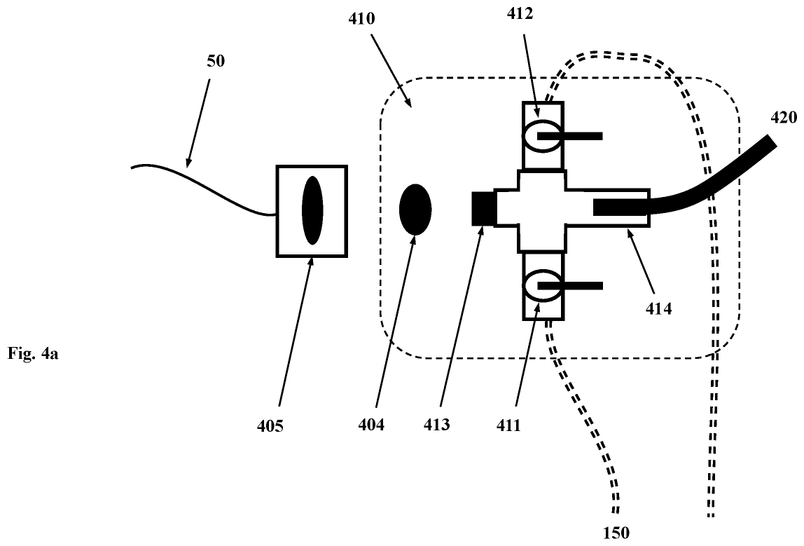

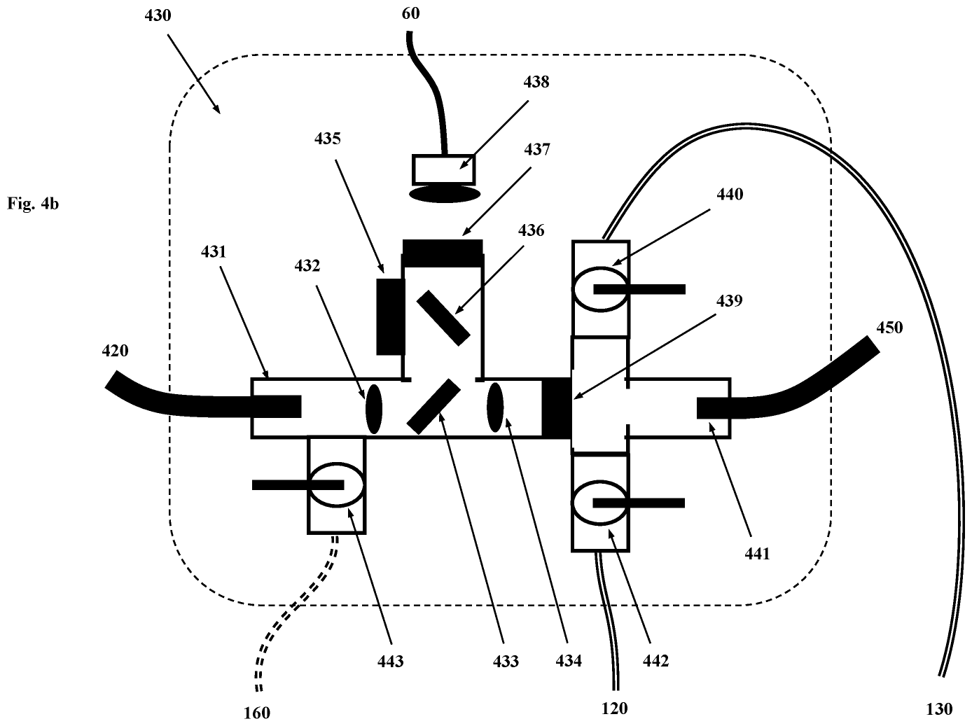

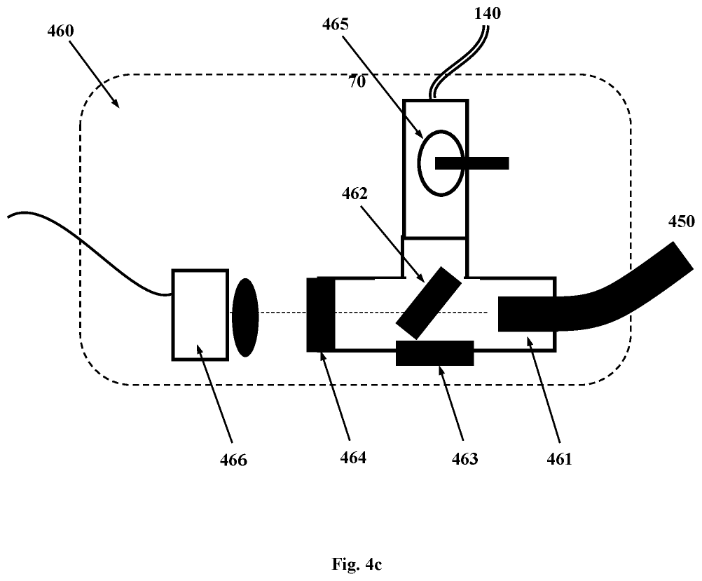

Reference is now made to FIG. 4 schematically showing the laser source (10) together with the molecular gas analysis subsystem (40) of the SRS spectrometer of the present invention according to a first embodiment. The laser source (10) is configured to generate a very high-peak power (typically 5-30 kW) and short pulses (typically 0.5-1.5 ns duration), with the repetition rate of typically 5-30 kHz.

The laser source (10) comprises a single high-power laser (15) configured to generate a high-power and short-pulse laser beam (pump), and a set of optical manipulators (403), which are designed to clean the laser (15), to set the final laser power and to couple the laser (15) to a power delivery optical fibre (50) suitable for transmitting said high-power laser pulses (pump) into the first optical interface (410) of the first fibre (420) of the gas analysis subsystem (40). An example of such fibre (50) is a Photonic-Crystal Hollow-Core Fibre. Different laser source configurations may use other types of this fibre. The set of optical manipulators (403) may include a half (λ/2) waveplate and a polariser.

In some embodiments, the high-high power laser (15) comprises:
(a) a laser driver and controller (11) designed to provide the electronic power to the high-power laser (15) and control a variety of parameters, such as current and temperature;
(b) a high-power laser source (12) suitable for generating high-power pulses and for pumping a diode-pumped solid-state (DPSS) laser (401);
(c) the DPSS laser (401), which is typically a Q-switched laser that generates high-power pulses; and
(d) an optional second harmonic generator (SHG) (402) suitable for receiving the high-power short pulses from the DPSS laser (401) and doubling the frequency of these pulses, thereby generating the high-power short-pulse laser beam at half the wavelength of said beam.

The high-power laser source (12) can be either a continuous-wave (CW) or pulsed laser with a typical average power of about 4-10 W and a pulse repetition rate that determines the repetition rate of the Q-switch. In a specific embodiment, the Q-switch is a passive Q-switch that is suitable for producing a main lasing line at 1064 nm. In another embodiment, the Q-switch is an active Q-switch or any other DPSS laser that generates high power pulse. The SHG (402) is an optional element of the high-high power laser (15) and configured to double the frequency of the laser pulses. For example, a laser beam generated by the DPSS laser (402) at 1064 nm is followed by the SHG (402) that doubles the lasing frequency and generates the pump laser beam at 532 nm. In other examples, a near-infrared laser is used without the SHG (402) to generate the pump laser beam. In many cases, the high-high power laser (15) is purchased as a complete off the shelf unit based on the 532-nm DPSS laser.

The gas analysis subsystem (40) is a reliable subsystem located near the measurement point. The high-power pulse laser (pump) is directed to the first optical interface (410) as set of valves and pipes allows pre-filling the hollow core of the first fibre (420) with specified static gases with a high concentration, these gases are identical to those analysed in terms of their chemical structure. The first optical interface (410) comprises a window for introducing a laser beam into the first hollow-core optical fibre (420). It also comprises a gas port/s connected to the gas inlet (150). Upon entering the first fibre (420), the laser beam interacts with the gas molecules present in the hollow core of the first fibre (420), thereby causing the SSRS phenomena. The first fibre (420) can be several meters long, depending on the original design of the spectrometer. Physical and optical characteristics of the first fibre (420) are predefined in accordance with obtained intensity of the laser beam and concentration and pressure of the prefilled gases inside its hollow core.

The second optical interface (430) is installed at the exit from the first fibre (420) and in front of the entrance to the second hollow-core optical fibre (450) and allows deflection of a portion of the laser beam for selecting it as a reference signal. Thus, the second optical interface (430) is configured to direct the combined light beam to the second fibre (450), select said combined light beam for intensity reference at each specific wavelength contained in the combined light beam, with each specific wavelength corresponding to each specific gas in the sample, vent the hollow core of the first fibre (420) for servicing, and inject the molecular gas sample into the hollow core of the second fibre (450).

A beam splitter is further installed between the first hollow-core optical fibre (420) and the second optical interface (430). This beam splitter is configured to split the combined light beam (comb signal) into a reference laser beam transmitted directly to the receiver subsystem (30) via the optical fibre (60) or through free space optics, and a main laser beam transmitted to the second optical interface (430). In other words, the beam splitter is used to sample small portion of the laser beam to be used as a reference signal, while the remaining larger portion of the laser beam is coupled with the second fibre (450) via a window. A small valve at the outlet of the first fibre (420) is used to flush this fibre when needed. Two small valves at the gas inlets (120) and (130) of the second fibre (450) allow the gas sample to be introduced into its hollow core.

The third optical interface (460), located at the exit of the second fibre (450), allows the gas sample to exit the second fibre (450) after the analysis through a small valve connected to a vent through a small diameter pipe (140). Here, the pump laser is blocked using a dichroic filter configured to direct the pump beam to an absorption surface. The rest of the Raman beam (after filtering the pump beam) exits the third optical interface (460) through the window and enters an optical fibre (70). This fibre (70) is connected to the receiver subsystem (30) for analysis. Alternatively, the rest of the Raman beam is transferred to the receiver subsystem (30) through free-space optics for spectral analysis.

Thus, the SRS spectrometer of the present invention is based on a combination of two hollow-core optical fibres (420 and 450). The hollow core of the first fibre (420), which is a Raman signal generator, is several meters long, includes two optical interfaces (410 and 430) at the ends and is filled with predetermined target gases with high concentration. This high concentration target gas mixture is selected in accordance with the analysed gases in the second fibre (450). The highly concentrated gases in the hollow core of the first optical fibre (420) are static, that is, they do not leave the first fibre and only serve to generate a Raman signal when their molecules interact with the pumping laser beam. Consequently, the high gas pressure along the first fibre is uniform.

Two optical interfaces (410 and 430) couple the laser beam into and out of the hollow core of the first fibre (420), respectively. The emitted light at the second optical interface (430) contains the pump laser signal and the generated Raman lines and constitutes a so-called “combined light beam” containing a comb of wavelengths. This wavelength comb exactly matches the light required to perform the SRS spectroscopy of gases in a gas sample in a second optical fibre (450). The emitted light at the second optical interface (430) is initially split into a small part coupled into the multimode optical fibre (60) and directed to the receiver subsystem (30) as a reference signal, and the main part coupled into the second hollow-core optical fibre (450) for performing the SRS spectroscopy of gases.

The second hollow-core optical fibre (450) is a shielded fibre several meters long, designed to withstand high gas pressure and high laser power. It includes two optical interfaces (430, 460) at the ends that allow light to enter and exit the fibre, respectively. The hollow core of this second fibre is independently filled with a relatively (compared to the first fibre) low-concentration gas sample to be analysed. In one embodiment, the gas sample is one or more tested gases flowing through a second hollow-core optical fibre (450), for example gases flowing through an industrial pipe to which the molecular gas analysis subsystem of the invention is connected. In another embodiment, a sample of one or more analysed gases is introduced into the hollow core of the second fibre (450) as a static sample. The interaction between the combined light generated in the first fibre (420) and the gas molecules in the sample injected into the second fibre (450) significantly amplifies the Raman signal and thus triggers the SRS mechanism. The light at the exit from the second fibre (450) contains information about the composition of the gas mixture in the gas sample and is sent to the receiver subsystem for spectral analysis and comparison with the reference signal.

Reference is now made to FIG. 4a which shows the expanded view of the first interface (410). The pump laser beam is delivered to this interface via the power delivery fibre (50). A fibre collimator lens (405) is configured to collimate the pump beam, and coupling lens (404) is configured to couple the pump laser beam into the first fibre (420).

As described above, the first optical interface (410) allows pre-filling the hollow core of the first fibre (420) with predetermined high-concentration static gases and directing the pumping laser beam to the same hollow core. In some embodiments, the first optical interface (410) comprises: a front window (413) with an anti-reflective coating, which directs the pump laser beam to the first hollow-core optical fibre (420); a gas inlet valve (411) that allows filling the hollow core of the first fibre (420) with predetermined high-concentration static gases and is connected through a small diameter gas line (150) to a gas source; a gas outlet valve (412) that allows gases to be purged at the inlet to replace and replenish gases; and a first connector (414) for the first hollow-core optical fibre (420) which is a sealed optical fibre interface configured for high gas pressure.

In a specific embodiment, the first hollow-core optical fibre (420) is a shielded hollow-core optical fibre based on a Photonic-Crystal Hollow-Core Fibre (PHCF) architecture that propagates light in the centre of its core in a single-mode while maintaining light polarisation. It enables high-power laser transmission without damaging the optical fibre while maintaining high gas pressure.

Reference is now made to FIG. 4b which shows the expanded view of the second optical interface (430) of the molecular gas analysis subsystem (40) of the SRS spectrometer. As mentioned above, the second optical interface (430) is located at the exit of the first hollow-core optical fibre (420) and in front of the entrance to the second hollow-core optical fibre (450). The second optical interface (430) allows a gas sample to be introduced into the hollow core of the second fibre (450) for molecular analysis. It also allows the combined light beam from the first fibre (420) to be transmitted to the second fibre (450) and to direct a small portion of this combined light beam to the receiver subsystem (30) as an intensity reference with respect to the Raman signal received from the molecular gas analysis subsystem (40) at each specific wavelength contained in the combined light beam and corresponding to each specific gas in the gas sample. Finally, the second optical interface (430) allows the first fibre (420) to be vented for maintenance. It is also important to note that the second optical interface (430) prevents the high-concentration static gases contained in the hollow core of the first fibre (420) from mixing with the analysed gases contained in the hollow core of the second fibre (450).

As schematically shown in FIG. 4b, the second optical interface (430) comprises:
(a) A second connector (431) for the first hollow-core optical fibre (420) which is a sealed optical fibre interface configured for high gas pressure;
(b) A gas outlet valve (443) of the first fibre (420) that allows this fibre to be ‘flushed’ and purged for replacement and replenishment of the high-concentration static gases, if necessary; this gas outlet valve (443) is connected to a vent through a small diameter gas pipe (160);
(c) An output beam collimator lens (432) which transfers the combined laser beam from the first fibre (420) to a free space collimated beam;
(d) A beam splitter (433) configured to split the combined light beam (comb signal) received from the first hollow-core optical fibre (420) into a reference beam transmitted directly to the receiver subsystem (30) via the multimode optical fibre (60) or through free space optics and the main beam transmitted to the second hollow-core optical fibre (450); for example, the combined light beam is split into the reference beam transmitting about 5-10% of the combined beam, and the main beam transmitting about 90-95% of the combined light beam;
(e) A dichroic mirror (436) configured to block the pump wavelength of the reference light beam and direct it to an absorption surface (435);
(f) A first window (437) with an anti-reflective coating which allows the reference light beam to exit the second optical interface (430);
(g) A reference beam fibre coupler (438) configured to couple the reference beam into the multimode fibre (60) to be sent to the receiver subsystem (30);
(h) A focusing lens (434) configured to direct the combined light beam onto the inlet of the second hollow-core optical fibre (450); it enables coupling of the combined light beam into the second fibre (450);
(i) A second window (439) with an anti-reflective coating which separates the high-concentration gases contained in the hollow core of the first fibre (420) from the analysed gases contained in the hollow core of the second fibre (450), and prevents the high-concentration gases in the hollow core of the first fibre (420) from mixing with the analysed gases in the hollow core of the second fibre (450). This second window (439) is able to withstand the pressure difference of several bars between the high-pressure gases of the first fibre and the analysed gases of the second fibre;
(j) A gas inlet valve (442) is connected through small diameter gas pipe (120), which is normally below 6 mm, to a source of the gas sample (for example, an industrial pipe containing the flow of one or more gases being analysed, or a reservoir containing the analysed gases). This valve allows the gas sample to be introduced into the hollow core of the second fibre (450). There is no need for any special sample preparation of the gas sample, which can be taken directly at the site of the molecular analysis. Only a micro-metric filter is needed to filter small particles, which can block the hollow core of the fibre. In addition, a pressure regulator is used to set the gas pressure to the working pressure, which is normally 1.5-10 bar;
(k) A gas outlet valve (440) is connected to an outlet pipe (130) and allows the analysed gases to be quickly flushed and purged from the fibre (450). As the gas volume (concentration) in the hollow core of the second fibre (450) is extremely low (several micro-litters), the analysed gases cannot be refreshed though the hollow core itself. The flow of the analysed gases through these two valves (442 and 440) ensures that the gas entering the hollow core of the second fibre is refreshed and constitutes the gas present only in the gas sample; and
(l) A third connector (441) which is a sealed optical fibre interface for connecting the second hollow-core optical fibre (450) to the second optical interface (430) of the first embodiment.

Reference is now made to FIG. 4c which shows the expanded view of the third optical interface (460) of the molecular gas analysis subsystem (40) of the SRS spectrometer. The third optical interface (460) is configured to receive the comb of the signals from the second fibre (450), block the pump signal, direct the amplified Raman signals to the receiver subsystem (30) via an optical fibre or through free space optics for spectral analysis, and ventilate the hollow core of the second optical fibre (450). In other words, it allows the analysed gases to be removed from the hollow core of the second fibre (450) and the amplified Raman signal emitted from the second fibre (450) to be directed to the receiver subsystem (30).

As shown schematically in FIG. 4c, the third optical interface (460) comprises: a fourth connector (461), which is a sealed optical fibre interface for connecting the second hollow-core optical fibre (450) to the third optical interface (460); a gas outlet valve (465) of the second fibre (450) connected to a vent through a small-diameter gas pipe (140) and enabling ventilation of the second fibre (450) from gases; a dichroic mirror (462) configured to split the comb of the signals from the second fibre (450) into a high-power pump beam, which is directed to an absorption surface (463) and blocked from exiting the third optical interface (460), and a beam containing amplified Raman signals passing through a third front window (464) with an anti-reflective coating. A set of optical filters is used to clean the amplified Raman optical signals from undesired wavelengths. For example, hydrocarbons have strong Raman lines at the wavenumber shift Δw˜2900 cm⁻¹. However, spectrally these lines are very close to each other and therefore, they are very difficult to separate (to measure separately). The filters are used for blocking these wavelengths. An output fibre connector (466) is configured to direct the Raman beam into the optical fibre (70) to be sent to the receiver subsystem (30) for spectral analysis.

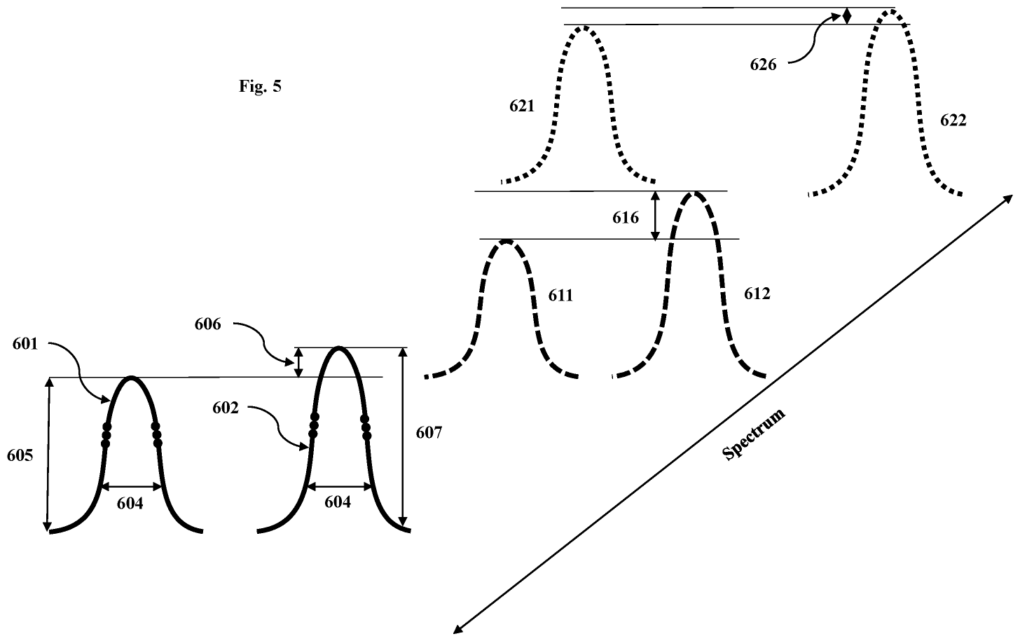

Reference is now made to FIG. 5 illustrating the concept behind the amplification of the Raman signals entering the receiver subsystem (30) of the SRS spectrometer of the present invention. As described above, the SRG signal generated in the second fibre (450) linearly correlates with the concentration of the corresponding target gas in the second fibre (450). The receiver subsystem (30) is mainly intended to extract the SRG of each wavelength and calculate the concentration out of the SRG for each target gas in the mixture. The two beams that enter the receiver subsystem (30) are the reference signal, which is the Raman signal at the entrance to the second fibre (450), and the Raman amplified signal, which is a sequence of short pulses having very short pulse duration (604) of typically 0.5-1.5 ns with the repetition rate of typically 5-20 kHz as generated by the laser (15). The pump and other undesired wavelengths are blocked at the exit from the second fibre (450). Each beam pulse then contains the plurality of Raman signals at different wavelengths (601, 611, 621) of the reference beam and at the wavelengths (602, 612, 622) of the Raman amplified beam. In order to extract the SRG for each target gas in the gas sample, the beams should be spectrally separated, followed by comparing the amplitude of the amplified Raman signal (607) to the amplitude of the reference Raman signal (605) and then extracting the SRG (606) from their difference. In order to measure the concentration of all target gases in the gas sample, the SRG at all wavelengths (606, 616, 626) should be calculated the same way.

The nature of the signals introduces the following challenges for extracting the SRG values:
very short pulses are captured at very low duty cycles;
in addition to the SRS phenomenon, the interaction of the laser beam with gases generates other quantum optics phenomena which adds significant noise to the signals;
at low gas concentrations, the SRG can be very low (down to 0.1 μW) “sitting” on a very high-amplitude signal (typically 0.1-10 W); and
at low gas concentrations, the SRG can be obscured by the thermal or vibrational noise of the system.
   Several signal-to-noise ratio improvement techniques and algorithms are therefore used in the receiver subsystem (30) to overcome these challenges as described below.

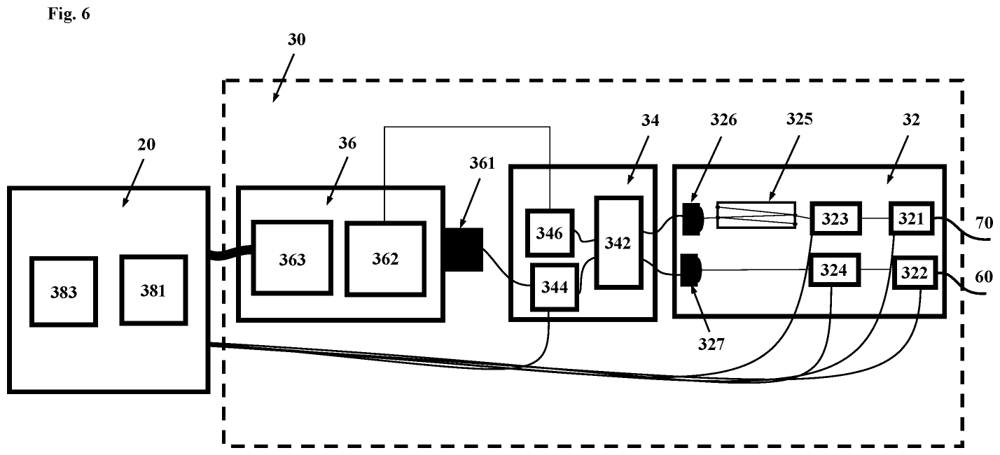

Reference is now made to FIG. 6 schematically showing the expanded view of the receiver subsystem (30) of the SRS spectrometer of the present invention. In this embodiment, the receiver subsystem (30) operates sequentially, i.e., it handles each single target gas from the gas sample at a time. This receiver subsystem (30) is configured to measure a certain target gas, to perform the measurement and then to measure another target gas. After measuring all the target gases, the concentration is reported to the host system and/or presented on the GUI (graphical user interface) of the processing unit (20) that displays the information, controls the measurement sequence and sets the receiver subsystem (30) to the specific gas parameters.

Signals from the gas analysis subsystem (40) are delivered to the optical frontend (32) of the receiver subsystem (30) via the optical fibres (60 and 70). In the optical frontend (32), each of the combined light beam is delivered to a monochromator (321, 322) to select only the wavelength which is relevant to the specific target gas from the gas sample that is being measured at that time. The monochromators (321, 322) are based, for example, on a rotated grating or on acousto-optic tuneable filter. In both cases, the monochromators are controlled by the electronic processing unit (20) to pass only a specific wavelength and block all other wavelengths. The monochromator (321, 322) is selected according to the spectral bands of interest as noted above. For example, Stokes lines generated by pumping at 532 nm or anti-Stokes lines generated by pumping at 1064 nm. It must have a wide dynamic range because the gas concentration is in a small difference range between the output of the second hollow core optical fibre and the reference. The spectral resolution must correspond to the minimal spectral difference of the target Raman signals, which is normally approximately 1 nm. In this embodiment, each beam is filtered via its dedicated monochromator. In other embodiments, the beam can be alternatively merged, so that each pulse will arrive at a different timing, and a single monochromator for this single beam will be used then.

In most cases, the intensity of Raman signals generated in the first fibre (420) is too high to be detected by a standard silicon photodiode. Controlled optical attenuators (323, 324) are therefore used to adjust the Raman signal intensity and ensure that the photodiodes (326, 327) will not become saturated. The wavelength attenuation is pre-calibrated, wherein for each measured target gas in the gas sample, a specific attenuation is configured by the electronic processing unit (20). A configurable optical delay line (325) is used to align the timing of the two pulses, so that the pulses are arrived at the photodiodes (326, 327) at the same time with the accuracy below 10 picoseconds. A pair of the high-speed silicon photodiodes (326, 327) is used to capture the laser pulses and convert them to electronics signals.

As shown in FIG. 6, two signals are introduced to the analogue frontend (34). As explained above (see FIG. 5 and the accompanied description), the SRG is a very tiny signal “sitting” on a very strong Raman signal. In order to achieve the sufficient resolution of the SRG, a high-speed high-resolution Analog-to-Digital Convertor (ADC), such as 5-GHz 14-bits ADC, is used. This is the most straightforward solution that may fit certain applications. However, at low gas concentrations, this resolution may not be enough, not to mention that it is a very expensive solution. Therefore, in some embodiments, the SRG is extracted and amplified using an analogue processor (342). At first stage of the analogue processing, the two signals are amplified. Then, using a high frequency operational amplifier, the SRG is extracted and amplified as explained above, i.e. by subtracting the reference signal from the amplified Raman signal. An automatic gain control (AGC) block (344) is used to optimise (amplify or attenuate) the SRG amplitude to the ADC resolution.

The amplified SRG in combined with the reference signal at different timing to a signal that continues two pulses, one is the SRG and the second is the generated Raman signal, both signals are required in order to calculate the concentration. These signals are converted to digital samples using a high-speed ADC (361) (typically 5 GHz, 8/10 bit). In addition, the analogue frontend (34) generates a trigger for the digital receiver (36) by generating a digital transistor-transistor logic (TTL) signal out of the reference signal (346). This trigger is required to indicate to the digital receiver (36) that the samples follow the trigger containing the amplified Raman data. This is because most of the samples acquired by the ADC are not relevant, since the duty-cycle of the signal is very low, which is only a few dozens of samples out of the millions of samples containing the relevant information. This mechanism turns the receiver subsystem (30) into an asynchronous subsystem suitable for handling signals with high timing jitter and without the need for an external trigger. It also enables the use of the passive Q-switch as a laser source, which is much simpler and cheaper that the active Q-switch.

As described above, the interaction of the high-power pump pulse with the gas in the hollow-core fibre generates the SRS phenomenon. However, additional quantum optics phenomena occur during the propagation of the pump pulse along the hollow-core fibre and generate additional optical signals, for example fluorescence signals. These optical signals are considered a noise in the system. The nature of the Raman phenomenon as well as the SRS is that this is an instantaneous phenomenon while the other phenomena are relatively slower (in the order of 5-500 ns). In addition to the optical noise, there is electronics noise in various frequencies. In low concentration, all these noises are higher than the SRG signal. A common approach to overcome this issue is to use a look-in-amplifier. However, the signals generated by the passive Q-switch have a very low duty-cycle and high jitter, and therefore, this method is impractical. Using a time-gated receiver, in which only the specific samples that contain the relevant information are selected and all the other samples with the noise are discarded, makes it possible to overcome this significant issue.

A hardware-based digital receiver (36), for example a FPGA (field-programmable gate array), can be attached to the high-speed ADC (361) to implement the time-gated receiver and to store the high-frequency information. All the samples from the ADC (361) are temporary stored in the digital receiver (36) comprising the digital receiver logic (362) configured to receive a trigger from the analogue frontend (346) that indicates the SRS event, and an output buffer (363) configured to select and store a predefined number of samples with the relevant information. When the digital receiver (36) stores a predefined SRS events, which is typically 256 to 1024 bit, it indicates to the electronic processing unit (20) that the SRS data is ready in the output buffer (363) and this data is copied to the electronic processing unit (20) for further processing.

The data processing software (SW) block (381) of the electronic processing unit (20) reads the SRS data received from the output buffer (363) and runs the signal-to-noise ratio improvement algorithms on the received SRS data, thereby generating the readable SRG value of a specific target gas. The concentration calculation SW block (383) is used for normalising the SRG values using the known amplification and attenuation parameters processed in the optical frontend (32) and in the analogue frontend (34), as well as for measuring the reference signal. Various pre-calibrated system parameters, for example gas pressure and temperature, together with physical constants, such as a Raman cross-section of a specific target gas, are used to calculate the concentration out of the SRG value.

Thus, the receiver subsystem (30) of the SRS spectrometer of the present invention is configured to measure intensity of each pair of the Raman signals, said pair of the Raman signals includes said amplified Raman signal received from the third optical interface (460) and said intensity reference signal received from the second optical interface (430) and corresponds to each target gas in the gas sample, to extract the SRG for each wavelength corresponding to each said target gas, and to calculate concentration of each said target gas based on said SRG and other system parameters, said receiver subsystem (30) comprising:

the optical frontend (32) configured to perform the spectral separation by selecting said individual pair of the Raman signals corresponding to a specific target gas and adjust the signal power to enable accurate conversion to the electronic signals;

the optical-to-electronic conversion devices (326, 327) configured to convert the optical signals to the electronic signals;

the analogue frontend (34) configured to amplify the SRG signal, combine the signals to enable operation with the single ADC (361) configured to convert short analogue pulses to digital samples, adjust the SRG in order to fully utilise the ADC resolution and generate the timing trigger to the digital receiver (36);

the digital receiver (36) configured to a preform a time-gated acquisition, detect said digital samples containing the SRG data, store them in the output buffer (363) while discarding all the noise samples, collect all the data of an individual gas from the gas sample and send the data to the electronic processing unit (20) for further processing; and

the electronic processing unit (20) configured to extract the SRG from the data received from the digital receiver (36), perform further improvement of the signal-to-noise ratio using digital signal processing algorithms, and calculate concentration of each specific gas in the gas sample based on the SRG and other recalibrated parameters.

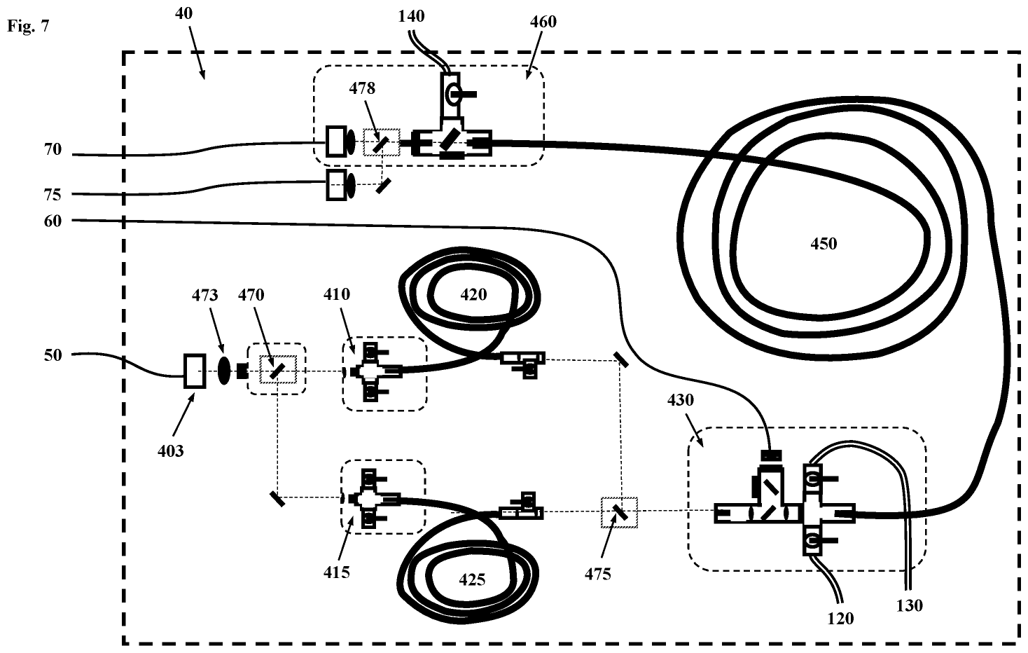

Reference is now made to FIG. 7, schematically showing the molecular gas analysis subsystem (40) of the SRS spectrometer of the present invention according to a second embodiment. In this embodiment, the molecular gas analysis subsystem (40) allows to improve the detection limit, to increase the number of target gases and to reduce the cross-spectral interference between the gases which have very close Raman shifts (in comparison to the separation limit of the spectral separation devices (321, 322) of choice). This enhancement of the gas analysis subsystem (40) is achieved by splitting the pump laser beam delivered by the power delivery fibre (50) into two different, orthogonal polarisations.

The splitting is performed with a polarising beam splitter (470) after the polarisation of the pump laser beam is adjusted by a half-wave plate (473) placed between the fibre (50) and the polarising beam splitter (470).

Two pump beams (with orthogonal polarisations) enter two different first hollow-core optical fibres (420 and 425) through their corresponding fibre interfaces (410 and 415) as described above and shown in FIG. 4. These generator optical fibres (420 and 425) are prefilled with different target gases with high concentration, where the gases having similar Raman shifts are fed into different fibres (420 and 425). Since hollow-core optical fibres are polarisation maintaining, each one of the generator optical fibres (420 and 425) emits polarised light (the SSRS light is emitted with the same polarisation of its pump), the relative polarisation of the two output light beams can be adjusted by carefully positioning the ends of the fibres. Polarisation beam combiner (475) combines the output of the generator fibres (420 and 425) into a single beam and allows coupling of this beam into the second hollow-core optical fibre (450) through the interface (430) as described in detail above.

The second hollow-core optical fibre (450) can contain all the target gases, even those with similar Raman shifts. As mentioned above, since these optical fibres are polarisation maintaining and the SRS occurs when the interacting beams are with the same polarisation, cross interference between gases with similar Raman shift is avoided, and orthogonal polarisations contain optical information about different gases.

Output polarisation beam splitter (478) separates the two polarisations, and they are coupled into two different fibres (70 and 75) transmitted to the receiver subsystem (30) for spectral analysis. These two different beams having different polarisation are analysed separately in different time domain. The above description makes use of polarisation in order to allow simultaneous detection of all target gases in the gas sample. Similar design of the molecular gas analysis subsystem (40) can use more than a single generator fibre intermittently using optical MUXs without special polarisation arrangements.

Thus, the SRS spectrometer of the present invention comprises the two major subsystems, which can be placed remotely from each other. The molecular gas analysis subsystem (40) is placed in close proximity to the measuring point of the gas sample, while the receiver subsystem (30) together with the laser source (10) are placed in a safe environment. In most cases, the measuring point is located outdoor, and frequently the outdoor environment is explosive and/or hazardous. The receiver subsystem (30) and the laser source (10) are optoelectrical subsystems which are very sensitive to the environment conditions (temperature, humidity etc.) Therefore, it is preferable to place the receiver subsystem (30) together with the laser source (10) in the protected environment, such as a control room or a closed shelter. It is possible to place the receiver and the laser near the measurement point, but it will be very complicated and expensive to add all the required protection means, such as an anti-explosive enclosure and temperature regulation mechanism. On the other hand, in many cases it is not possible and/or very complicated to deliver the gas sample to protected environment, since the sample can be a flow of an explosive and/or hazardous gas. Also, in some cases, the composition of the sample gas changes when the gas flows through a long sampling pipe, resulting in inaccurate measurements.

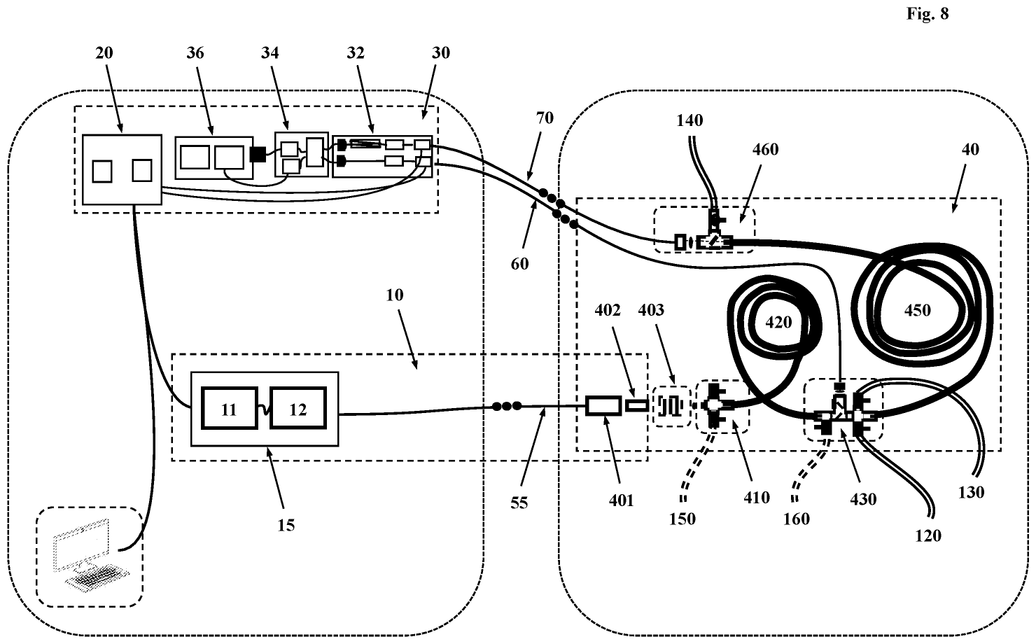

Reference is now made to FIG. 8 showing the SRS spectrometer of the present invention according to a third embodiment. In the first embodiment shown in FIG. 1 and described above, the laser source (10) is placed in a protected environment, and the high-power short pulses from the single high-power laser (15) are delivered to the molecular gas analysis subsystem (40) via a special optical power delivery fibre (50), which is also called a “power-over-fibre” (PoF) and which carries optical power used as an energy source rather than carrying data. A regular high-power fibre cannot maintain the polarisation of the beam necessary for the SSRS spectroscopy. Also, since the pulse intensity in the fibre is very high (above 5 MW/cm²), the regular high-power fibre will be damaged by such high intensity. Consequently, only the special optical power delivery fibre can be used, such as a hollow-core fibre. However, these fibres are expensive and do not fit for remote operation over long distances.

As shown in FIG. 8, the third embodiment therefore presents a different solution to maintain the separation of the SRS spectrometer of the present invention into the two subsystems obviating the need for the special optical power delivery fibre. In the third embodiment shown in FIG. 8, the laser source (10) is separated into two parts. The single high-power laser (15) comprising the laser driver and controller (11) and the high-power laser source (12) (typically a 808-nm high-power multi-emitter laser diode) is placed in a safe environment, because it contains high-power and sensitive electronic elements. The DPSS laser (401), which is typically a Q-switched laser, and the SHG (402) are attached to the molecular gas analysis subsystem (40) and placed in close proximity to the measuring point of the gas sample. In this case, the Q-switch must be a passive Q-switch in order to ensure that the molecular gas analysis subsystem (40) placed near the measurement point is purely optical without any electronics.

In any case, the receiver subsystem (30) is asynchronous, i.e., it is designed to generate the timing trigger from the Raman signal itself without the need for an external trigger from the laser source. The separation of the laser source from the molecular gas analysis subsystem (40) allows using an off-the-shelf high-power optical fibre (55) to deliver the laser beam to the molecular gas analysis subsystem (40), since the high-power laser source (12) in this case is a multimode CW laser which is typically 4-10 W CW 808-nm laser. This is in contrast to a high-power short-pulse laser that typically produces 1-ns pulses with 50 KW peak power at 532 nm and requires a regular high-power optical fibre, for example a 200-μm ϕ multimode high-power fibre which can be used with the CW multimode laser.

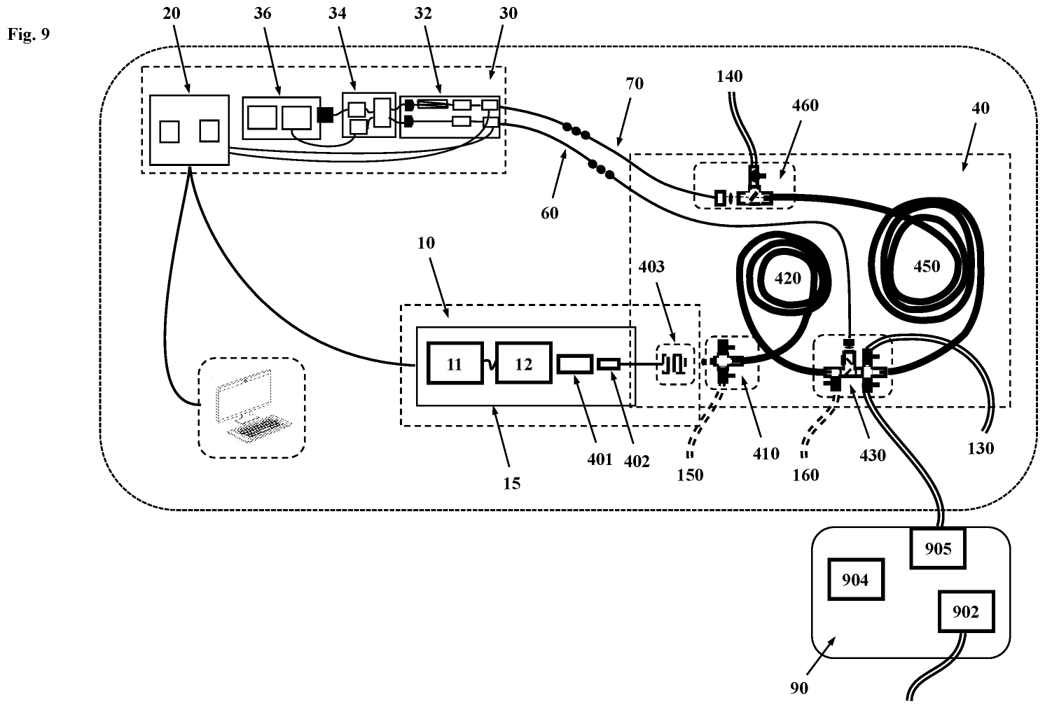

Reference is now made to FIG. 9 showing the SRS spectrometer of the present invention according to a fourth embodiments. While the previous embodiments introduce the SRS spectrometer which is divided into two parts, the fourth embodiment is directed to the SRS spectrometer of the invention having all the subsystems “under one roof”, i.e. placed in the same, single enclosure, frame or room. This configuration fits laboratories or can be used for analysis of non-explosive gases, such as flue gas emitted into the atmosphere that needs to be monitored for environmental protection. In such spectrometer, the laser source (10) is attached to the molecular gas analysis subsystem (40) and the laser beam is delivered in free space, thereby simplifying the entire laser delivery system.

As shown in FIG. 9, a gas sample delivery subsystem (90) is added to enable continuous monitoring of the process. The gas sample delivery subsystem (90) comprises valves, pumps, pressure regulators and filters (902, 904). In some cases, an optional sample preparation module (905) is also included. The sample preparation, which includes heating to a specific temperature and drying of the sample, is crucial for IR-based spectrometers, such as FTIR (Fourier Transform Infrared) or NDIR GFC (Non-Dispersive Infrared Gas Filter Correlation), since measurements with these spectrometers are very sensitive to the sample conditions. While this sample preparation is complicated and expensive, the SRS spectrometer of the present invention is not sensitive to the sample conditions, which considerably simplifies the measurements. In the case of high humidity, such as power plant emission, a partial drying of the gas sample may be required though. In that case, the sample preparation module (905) may be added in a form of a microfluidic drying module saving significant cost on handling gas samples with sample volumes in the range of microliters.

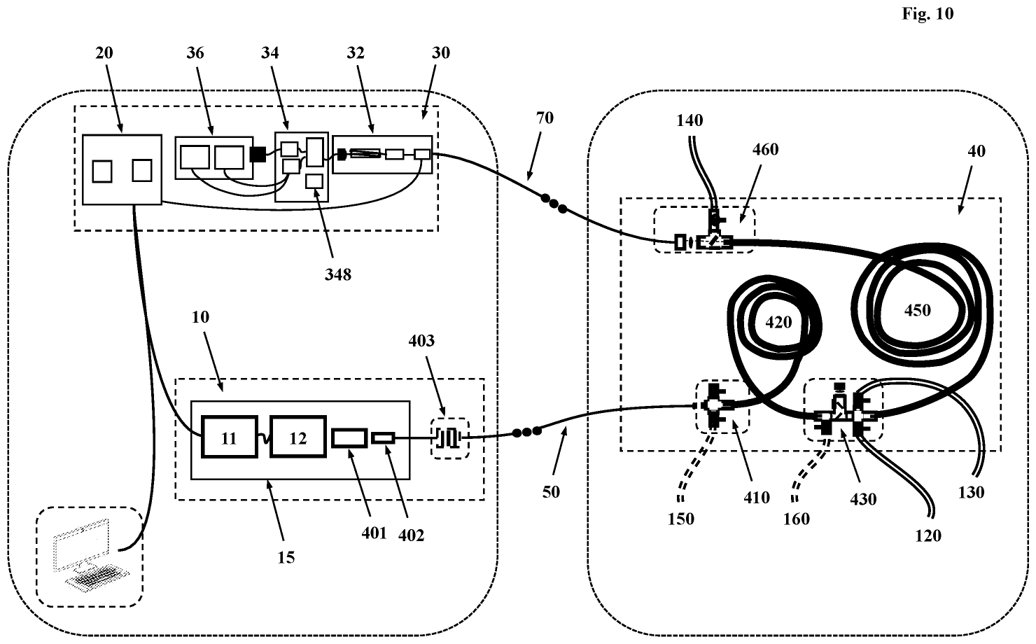

Reference is now made to FIG. 10 showing the SRS spectrometer of the present invention according to a fifth embodiment. In this embodiment, the reference signal at the entrance to the second fibre (450) is not measured, thus simplifying the entire optical system. The second optical interface (430) in the molecular gas analysis subsystem (40) does not include a sampling function, and the beam from the first fibre (420) is delivered to the second fibre (450) as is. The fibre (60) that delivers the reference signal to the receiver subsystem (30) in the above configurations is not required here. The optical frontend (32) of the receiver subsystem (30) therefore includes only one optical processing path vs two parallel processing paths in the above configurations. However, the significant simplicity and cost saving on the optical side of the SRS spectrometer of the present embodiment requires a more complex analogue frontend (34) and a more complex digital receiver (36).

In order to extract the SRG of each gas in the gas sample, the power of the Raman signal must be used. In the first configuration (FIG. 1), the power of the Raman signal is calculated from the reference signal sample. However, in the present case (FIG. 10), it is “artificially” generated for each gas by the receiver subsystem (30) as follows. A reference gas, which is an additional gas that is not present in the gas sample, is added to the first fibre (420), after which a Raman signal of this reference gas is generated in the first fibre (420). The power or intensity of this Raman signal does not change in the second fibre (450).

The receiver subsystem (30) measures the power of this signal frequently as this power can indicate of any changes in other Raman signals generated in the first fibre (420). The ratio between this reference gas signal and the Raman signals of each target gas in the sample is constant and can be measured during system calibration process and stored in the electronic processing unit (20). The reference signal power for each gas in the gas sample is then calculated from the reference gas Raman signal and ratio stored in the electronic processing unit (20).

As shown in FIG. 10, an additional block (348) is added to the analogue frontend (34) of the present configuration. This block (348) includes DAC for each gas in the sample and a software for the DAC to generate an analogue signal with the power of the corresponding reference signal. A radio-frequency (RF) mixer is used to generate a pulse at the timing of the Raman amplified signal with the power of the reference signal. From this point on, the receiver processing chain continues as described in the first embodiment.

The SRS spectrometer of the present invention can be used for real-time, high-resolution, on-site gas analysis for many applications in all segments of the process industry, such as oil and gas, renewable energy, chemicals, semiconductors, food and more. However, each specific application must be tuned to a set of target gases within the predefined (expected) concentration range. The process of tuning the SRS spectrometer for each specific application includes setting the following parameters: the pump laser power, the length of the two hollow-core fibres (420 and 450), and the predefined concentration of each gas in the first fibre (420). For a given laser power and fibre length, the concentration of each gas in the first fibre (420) must be determined according to the expected concentration of the same target gas and according to the Raman cross section of that gas in the gas sample in the second fibre (450). In a typical gas with a typical Raman cross-section and an expected concentration of 10-5000 ppm, the gas concentration in the first fibre (420) should be set so that the generated Raman signal is between 100 mW and 1 W at the output from the first fibre (420).

The dynamic range of the receiver subsystem (30) is very wide and can be calibrated to detect a wide range of concentrations over a wide range of Raman signal powers. If the concentration of the target gas in the gas sample is expected to be very low and the gas has a relatively large Raman cross-section, such as pentane in natural gas, a large SRS amplification is required, and this gas concentration in the first fibre (420) must therefore be high. If the concentration of the target gas in the gas sample is expected to be low and the gas has a small Raman cross-section, such as carbon dioxide, the concentration of this gas in the first fibre (420) can be kept moderate. In a special case where the concentration of the target gas in the gas sample is expected to be very high, such as methane in natural gas, the first fibre (420) is not prefilled with this gas at all, and the concentration of this gas is measured based on the Raman signal of this gas generated in the second fibre (450), which is based on the SSRS phenomenon. Calibrating such a gas would be a special case because the Raman versus concentration curve for this gas is not linear. In case there is a wide variety of target gases and concentrations in the gas sample, the pump laser power, which is constant in the fifth configuration described above, can be electronically controlled and adjusted for each target gas, thereby increasing the dynamic range of the SRS spectrometer.

In case the expected target gas composition contains a very wide concentration range that cannot be achieved by setting the target gas concentration in the first fibre (420), dynamic control of the pump laser can be used to increase the flexibility of the system. This is done using a set of optical manipulators (403) in the laser source subsystem (10). For example, if the expected concentration of one of the target gases in a gas sample is very low (1-10 ppm) when measuring that gas, the pump laser power can be increased to generate high pump power and high-power Raman signal in the first fibre (420). The increased power of these two lasers increases the sensitivity and improves the detection limit of the system.

In some cases where a very high-resolution measurement for a specific gas is required, the acquisition time for that gas can be increased by defining larger blocks of repeated SRG samples of that specific gas stored in the digital receiver (36). A large number of repetitive samples provides an improved signal-to-noise ratio and better measurement resolution.

As described above, the measured SRG of each gas is proportional to the concentration of that gas in the gas sample. The measured SRG is the electronic amplitude that must be normalised to optical power using dynamic parameters such as gain and attenuation recorded via the optical interface (32) and analogue interface (34), as well as constant parameters such as the conversion curve of the photodiode.

When the gas concentration in the sample is low (for example, the gas concentration in the second fibre), the relationship between the gas concentration and the measured SRG can be described by the following equation:

$$SRG = C \frac{{ω}_{p}}{{ω}_{s}} {σ}_{R} {P}_{p} {P}_{s} \frac{Z}{A} {X}_{n}$$

where C is the target gas concentration;

$$\frac{{ω}_{p}}{{ω}_{s}}$$

is the ratio between the pump frequency and the Raman signal frequency of the target gas,
σ_{R} is the normalized Raman cross-section of the target gas,
Pₚ is the pump power in the second fibre (450),
Pₛ is the Raman power in the second fibre (450),

$$\frac{Z}{A}$$

is the fibre length divided by the fibre cross-sectional area, and
Xₙ are the system parameters, i.e., physical constants and parameters that can be defined and measured, such as pressure or temperature.

Using the above equation, the concentration of the target gas is calculated. Another practical option is to calibrate the system, measure the SRG at multiple concentrations for each gas, create a look-up table, and use that table to extract the concentration with interpretation of the SRG values between the calibrated points.

As described above, the molecular gas analysis subsystem (40) generates Raman signals of all target gases in the gas sample simultaneously, while the receiver subsystem (30) operates sequentially (processes one gas at a time) using the sequencer and the SW block in the electronic processing unit (20) that controls this sequence. A method for measuring concentration of the target gases in the gas sample comprises the following steps:
Step I: Configure the receiver subsystem (30) parameters to measure a specific target gas in the gas sample, said step comprising:
   set the monochromator (321, 322) to the measured target gas corresponding Raman wavelength,
   set the power of the pump laser using the set of optical manipulators (403) in the laser source subsystem (10),
   set the optical attenuation (323, 324) and AGC (344) parameters predefined for the target gas, and verify that the received Raman signal is not overflowed or underflowed (otherwise, update the parameters), and
   Set the number of SRG samples (SRG block size) to be stored in the digital receiver (36);
Step 2: Indicate to the digital receiver (36) to run the time-gated acquisition and to store predefined number of the SRG samples;
Step 3: Upon completion of Step 2, the digital receiver (36) indicates to the electronic processing unit (20) that the data is ready;
Step 4: The data is read from the digital receiver (36) and DSP algorithms are run to extract the SRG value for the target gas;
Step 5: The concentration is calculated from the SRG using the calculation methods described above;
Step 6: Repetition of Steps 1 to 5 for all the gases in the gas sample according to a precompiled target gas list; and
Step 7: The concentration of the target gases in the gas sample is sent to the host system and/or presented on the GUI (graphical user interface) of the processing unit (20).

While certain features of the present application have been illustrated and described herein, many modifications, substitutions, changes, and equivalents will be apparent to those of ordinary skill in the art. It is, therefore, to be understood that the appended claims are intended to cover all such modifications and changes as fall within the true spirit of the present application.

1. A stimulated Raman scattering (SRS) spectrometer for real-time, high-resolution molecular analysis of one or more gases in a gas sample, said SRS spectrometer is designed to measure concentration of said one or more gases in the gas sample and comprises:
A. a laser source (10) comprising a single high-power laser (15), which is configured to generate a high-power, short-pulse laser beam (pump), and a set of optical manipulators (403), which are designed to clean the spectrum of the single high-power laser (15), to set the final laser power and to direct said laser beam (pump) to a first optical interface (410) of a first hollow-core optical fibre (420);
B. a molecular gas analysis subsystem (40) comprising:
(a) the first optical interface (410) configured to couple said laser beam into the first hollow-core optical fibre (420) and to enable prefilling said first hollow-core optical fibre (420) with one or more static gases in high concentration, said gases are the same gases as those being analysed;
(b) the first hollow-core optical fibre (420), which is prefilled with said static gases in high concentration, said first fibre (420) is a “signal generator” fibre suitable for generating and emitting a self-stimulated Raman signal, which co-propagates with said laser beam (pump signal) as a combined light beam (comb signal) along the first fibre (420) to a second optical interface (430) of the first fibre (420);
(c) the second optical interface (430) configured to perform spectral filtration of said combined light beam, to sample said combined light beam for intensity reference and to direct the intensity reference signal to a receiver subsystem (30), to direct said combined light beam to a second hollow-core optical fibre (450), to vent the first fibre (420) for maintenance purposes, and to provide the gas sample for the molecular analysis in the second fibre (450);
(d) the second hollow-core optical fibre (450), which contains the gas sample, said second fibre (450) is a “sample analysis” fibre suitable for receiving said combined light beam from the second optical interface (430) and transferring said combined light beam along its hollow core, wherein said combined light beam interacts with molecules of the target gases in the gas sample inside the hollow core of the second fibre (450), thus amplifying the Raman signals in the combined light beam by stimulated Raman scattering on said molecules for each gas being analysed in the gas sample, said amplification is performed with the specific comb containing the pump signal (laser beam) and said Raman signals in the combined light beam generated in the first fibre (420), and results in amplifying the intensity of the corresponding Raman signals (resulting in stimulated Raman gain); and
(e) a third optical interface (460) configured to receive the comb of said amplified Raman signals from the second fibre (450), to direct the amplified Raman signals to the receiver subsystem (30) via an optical fibre or through free space optics for spectral analysis, to block the pump signal (laser beam), and to vent the second fibre (450); and
C. the receiver subsystem (30) designed to receive the amplified Raman signals from the third optical interface (460), to receive the intensity reference signals from the second optical interface (430), to spectrally separate each of said received signals (the Raman signals and the reference signals) to its individual Raman lines corresponding to the target gases, to convert optical signals to electronic signals, to extract the stimulated Raman gain (SRG) at each wavelength by comparing the intensity of the reference signal to the intensity of the amplified Raman signal for each wavelength, and to calculate each gas concentration out of this SRG comparison, said receiver subsystem (30) comprises:
(a) an optical frontend (32) configured to perform said spectral separation by selecting a single wavelength corresponding to a wavelength of a certain Raman line, and to control the intensity of the optical signals prior to their conversion to the electronic signals using photodiodes;
(b) at least one optical-to-electronic conversion device (326, 327) configured to capture the laser pulses (optical signals) and convert the optical signals to the electronic signals;
(c) an analogue frontend (34) configured to amplify the SRG signal and to generate a timing trigger to a digital receiver (36);
(d) a digital receiver (36) configured to convert analogue signals to digital samples, to perform a time-gated acquisition for improving signal-to-noise ratio, and to store blocks of repeated SRG samples of a single gas; and
(e) an electronic processing unit (20) configured to read the blocks of the SRG samples, perform further improvement of the signal-to-noise ratio of said SRG signal using digital signal processing algorithms, extract the SRG at each said wavelength and calculate concentration of each said gas in the sample.

2. The SRS spectrometer of claim 1, wherein said gas sample is a flow of one or more gases being analysed, flowing through the second hollow-core optical fibre.

3. The SRS spectrometer of claim 1, wherein said gas sample is one or more static gases being analysed, introduced into the second hollow-core optical fibre.

4. The SRS spectrometer of claim 1, wherein said single high-power laser (15) comprises:
(e) a laser driver and controller (11) designed to provide the electronic power to the high-power laser (15) and control a variety of parameters, such as current and temperature;
(f) a high-power laser source (12) suitable for generating high-power laser beam and for pumping a diode-pumped solid-state (DPSS) laser (401);
(g) the DPSS laser (401) suitable for converting the high-power laser beam generated by the high-power laser source (12) to high-power pulses; and
(h) an optional second harmonic generator (SHG) (402) configured to receive the high-power short pulses from the DPSS laser (401) and double the frequency of these pulses, thereby generating the high-power short-pulse laser beam at half the wavelength of said beam.

5. The SRS spectrometer of claim 1, wherein said laser source (10), said molecular gas analysis subsystem (40) and said receiver subsystem (30) are installed in the same single enclosure, frame or room, in a protected environment.

6. The SRS spectrometer of claim 1, wherein said laser source (10) and said receiver subsystem (30) are installed in the same single enclosure, frame or room, in a protected environment, and said molecular gas analysis subsystem (40) is placed separately in close proximity to source of the gas sample.

7. The SRS spectrometer of claim 1, wherein said single high-power laser (15) is installed in a protected environment, and said high-power laser pulses (pump) are delivered to the molecular gas analysis subsystem (40) via high-power fibre optics.

8. The SRS spectrometer of claim 1, further comprising an optical fibre (50) connecting the laser source (10) with the molecular gas analysis subsystem (40) and suitable for transmitting said high-power laser pulses (pump) from the optical manipulators (403) into the first optical interface (410) of the molecular gas analysis subsystem (40), said optical manipulators (403) are configured to couple said single high-power laser (15) to said optical fibre (50).

9. The SRS spectrometer of claim 4, wherein said laser driver and controller (11) and the high-power laser source (12) are installed in the same single enclosure, frame or room together with the receiver subsystem (30), in a protected environment, and the DPSS laser (401) and the optional (SHG) (402) together with the molecular gas analysis subsystem (40) are installed in close proximity to source of the gas sample.

10. The SRS spectrometer of claim 4, wherein said DPSS laser (401) is a passive Q-switch.

11. The SRS spectrometer of claim 1, wherein said molecular gas analysis subsystem (40) is a purely optical, passive subsystem that does not contain any electronic components.

12. The SRS spectrometer of claim 1, wherein said first optical interface (410) comprises:
a front window (413) with an anti-reflective coating, configured to direct the pump laser beam to the first hollow-core optical fibre (420);
a gas inlet valve (411) that allows filling the hollow core of the first fibre (420) with predetermined high-concentration static gases and connected through a gas line (150) to a gas source;
a gas outlet valve (412) that allows gases to be purged at the inlet to replace and replenish gases; and
a first connector (414) for the first hollow-core optical fibre (420) which is a sealed optical fibre interface configured for high gas pressure.

13. The SRS spectrometer of claim 1, wherein said first hollow-core optical fibre (420) is a shielded hollow-core optical fibre based on a photonic crystal fibre architecture, configured to propagate light in the centre of its core under high-gas pressure in a single-mode while maintaining light polarisation.

14. The SRS spectrometer of claim 1, wherein said molecular gas analysis subsystem (40) further comprising a beam splitter (433) installed between the first hollow-core optical fibre (420) and the second hollow-core optical fibre (450) and configured to split said combined light beam (comb signal) into a reference laser beam transmitted directly to the receiver subsystem (30) via an optical fibre or through free space optics, and a main laser beam transmitted to the second hollow-core optical fibre (450).

15. The SRS spectrometer of claim 1, wherein said second interface (430) comprises:
a second connector (431) for the first hollow-core optical fibre (420) which is a sealed optical fibre interface designed for high-gas pressure;
a gas outlet valve (443) of the first fibre (420) that allows this fibre to be ‘flushed’ and purged for replacement and replenishment of the high-concentration static gases, said gas outlet valve (443) is connected to a vent through a gas pipe (160);
an output beam collimator lens (432) configured to transfer the combined laser beam from the first fibre (420) to a free space collimated beam;
a beam splitter (433) configured to split the combined light beam (comb signal) received from the first hollow-core optical fibre (420) into a reference beam transmitted directly to the receiver subsystem (30) via a multimode optical fibre (60) or through free space optics and the main beam transmitted to the second hollow-core optical fibre (450);
a dichroic mirror (436) configured to block the pump wavelength of the reference light beam and direct it to an absorption surface (435);
a first window (437) with an anti-reflective coating which allows the reference light beam to exit the second optical interface (430);
a reference beam fibre coupler (438) configured to couple the reference beam into the multimode fibre (60) to be sent to the receiver subsystem (30);
a focusing lens (434) configured to direct the combined light beam onto the inlet of the second hollow-core optical fibre (450);
a second window (439) with an anti-reflective coating designed to separate the high-concentration gases contained in the hollow core of the first fibre (420) from the analysed gases contained in the hollow core of the second fibre (450), and prevent the high-concentration gases in the hollow core of the first fibre (420) from mixing with the analysed gases in the hollow core of the second fibre (450); said second window (439) is capable of withstanding the pressure difference of several bars between the high-pressure gases present in the first fibre (420) and the analysed gases present in the second fibre (450);
a gas inlet valve (442) connected through a gas pipe (120) to a source of the gas sample and designed to introduce the gas sample into the hollow core of the second fibre (450);
a gas outlet valve (440) connected to an outlet pipe (130) and designed to let the analysed gases from the gas sample to be flushed and purged from the fibre (450); and
a third connector (441), which is a sealed optical fibre interface, for connecting the second hollow-core optical fibre (450) to the second optical interface (430).

16. The SRS spectrometer of claim 1, wherein said third optical interface (460) comprises:
a fourth connector (461), which is a sealed optical fibre interface, for connecting the second hollow-core optical fibre (450) to the third optical interface (460);
a gas outlet valve (465) of the second fibre (450) connected to a vent through a gas pipe (140) and enabling ventilation of the second fibre (450) from gases;
a dichroic mirror (462) configured to split the comb of the signals from the second fibre (450) into two beams: a high-power pump beam directed to an absorption surface (463) and blocked from exiting the third optical interface (460), and a beam containing amplified Raman signals passing through a third front window (464) with an anti-reflective coating; and
an output fibre connector (466) configured to direct said Raman beam from said third front window (464) into the multimode optical fibre (70) to be sent to the receiver subsystem (30) for spectral analysis.

17. The SRS spectrometer of claim 1, wherein said receiver subsystem (30) is configured to operate sequentially by measuring each individual gas from the gas sample at a time, said measuring includes extracting the SRG signal and calculating the concentration of each said gas in a sequential manner, and upon measuring all the gases in the gas sample, to report to a host system and/or display results on a GUI (graphical user interface) of the electronic processing unit (20).

18. The SRS spectrometer of claim 17, wherein said electronic processing unit (20) is configured to control the measurement sequence and set said receiver subsystem (30) to specific gas parameters.

19. The SRS spectrometer of claim 1, wherein said receiver subsystem (30) further comprises at least one monochromator (321, 322), to which the combined light beam is delivered from the molecular gas analysis subsystem (40) via optical fibres (60 and/or 70), said monochromator is configured to select only the wavelength which corresponds to the specific gas from the gas sample that is being measured at that time and controlled by the electronic processing unit (20) to pass only said specific wavelength and block all other wavelengths.

20. The SRS spectrometer of claim 1, wherein said monochromator (321, 322) is a rotated grating or an acousto-optic tuneable filter.

21. The SRS spectrometer of claim 1, wherein said receiver subsystem (30) further comprises at least one controlled optical attenuator (323, 324) designed to adjust the Raman signal intensity and prevent the optical-to-electronic conversion device (326, 327) from saturation.

22. The SRS spectrometer of claim 1, wherein said receiver subsystem (30) further comprises a configurable optical delay line (325) designed to align the timing of two pulses, so that the pulses are arrived at the optical-to-electronic conversion device (326, 327) at the same time with the accuracy below 10 picoseconds.

23. The SRS spectrometer of claim 1, wherein said receiver subsystem (30) further comprises an analogue processor (342) designed to extract and amplify the SRG signal by subtracting the reference signal from the amplified Raman signal.

24. The SRS spectrometer of claim 23, wherein said receiver subsystem (30) further comprises an automatic gain control (AGC) block (344), which is designed to optimise (amplify or attenuate) the SRG amplitude to the analogue-to-digital (ADC) resolution.

25. The SRS spectrometer of claim 1, wherein said receiver subsystem (30) further comprises an analogue-to-digital convertor (ADC) (361) suitable for capturing short SRG pulses.

26. The SRS spectrometer of claim 25, wherein the digital receiver (36) is a hardware-based receiver attached to the ADC (361), said digital receiver (36) is configured to implement a time-gated acquisition and store high-frequency information.

27. The SRS spectrometer of claim 1, wherein said molecular gas analysis subsystem (40) further comprises an additional optical interface (415) and an additional generator hollow-core optical fibre (425), said molecular gas analysis subsystem (40) is designed to split the pump laser beam into two different orthogonal polarisations.

28. The SRS spectrometer of claim 27, wherein said molecular gas analysis subsystem (40) further comprises:
a half-wave plate (473) configured to adjust polarisation of the pump laser beam and a polarising beam splitter (470) placed after the half-wave plate (473) and designed to split the pump laser beam into two pump laser beams having orthogonal polarisations and direct each said orthogonally polarised laser beam into the corresponding optical interface (410, 415);
a polarisation beam combiner (475) configured to combine the output beams of the generator fibres (420 and 425) into a single beam and allows coupling of this beam into the second hollow-core optical fibre (450) through the second interface (430); and
an output polarisation beam splitter (478) installed in the third interface (460) and configured to separate the two orthogonal polarisations and couple them into two different fibres (70 and 75) transmitted the two orthogonally polarised light beams to the receiver subsystem (30) for spectral analysis.

29. The SRS spectrometer of claim 1, further comprising a microfluidic gas sample preparation module (905) configured to control inlet temperature and humidity at very low flow rates as needed by the measurement subsystem.

30. The SRS spectrometer of claim 1, wherein said first hollow-core optical fibre (420) is further prefilled with a “reference gas”, which is an additional gas not present in the gas sample, said reference gas is suitable for generating a Raman reference signal in the first fibre (420), wherein the power of this Raman reference signal does not change in the second fibre (450) resulting in the ratio between this Raman reference gas signal and the Raman signal of each individual gas in the sample to be constant, thus obviating the need for measuring the reference signal at the entrance to the second fibre (450) and reducing the optical processing paths in the receiver subsystem (30) to only one optical processing path.

31. The SRS spectrometer of claim 1, wherein said receiver subsystem (30) has multiple receiver paths and is configured to operate in parallel by measuring each individual gas from the gas sample at a time, said measuring includes extracting the SRG signal and calculating the concentration of each said gas in parallel to all the gases in the gas sample using said multiple receiver paths.

32. The SRS spectrometer of claim 1 suitable for molecular analysis of all Raman active gases (that exhibit Raman lines or appear in Raman spectra) in the resolution range of 1 ppm to 100% without modification of the system hardware or software

33. The SRS spectrometer of claim 1, where the target gases in the gas sample correspond to the composition of the gases prefilled in the first hollow core fiber (420).

34. The SRS spectrometer of claim 33, where target resolution of each target gas is configured by:
setting the concentration of the same gas in the prefilled gas mixture in the first fibre (420),
setting the power of the high-power, short-pulse laser beam (pump) (15) using the set of optical manipulators (403), and/or
setting the number of the SRG samples (the SRG block size) being stored in the digital receiver (36).

35. The SRS spectrometer of claim 1, where the resolution of the molecular analysis is defined by setting the length of the first fibre (420) and the second fibre (450).

36. A method for measuring concentration of gases in the gas sample with the SRS spectrometer of any one of claims 1-35, said method comprising:
Step I: Configure the receiver subsystem (30) parameters to measure a specific target gas in the gas sample, said step comprising:
set the monochromator (321, 322) to the measured target gas corresponding Raman wavelength,
set the power of the pump laser using the set of optical manipulators (403) in the laser source subsystem (10),
set the optical attenuation (323, 324) and AGC (344) parameters predefined for the target gas, and verify that the received Raman signal is not overflowed or underflowed (otherwise, update the parameters), and
Set the number of SRG samples (SRG block size) to be stored in the digital receiver (36);
Step 2: Indicate to the digital receiver (36) to run the time-gated acquisition and to store predefined number of the SRG samples;
Step 3: Upon completion of Step 2, the digital receiver (36) indicates to the electronic processing unit (20) that the data is ready;
Step 4: The data is read from the digital receiver (36) and DSP algorithms are run to extract the SRG value for the target gas;
Step 5: The concentration is calculated from the SRG using the calculation methods described above;
Step 6: Repetition of Steps 1 to 5 for all the gases in the gas sample according to a precompiled target gas list; and
Step 7: The concentration of the target gases in the gas sample is sent to the host system and/or presented on the GUI (graphical user interface) of the processing unit (20).

37. An online, real-time, high-resolution, industrial gas analyser comprising the SRS spectrometer of any one of claims 1-35.

38. The online, real-time, high-resolution, industrial gas analyser of claim 37 suitable for operation in explosive or hazardous environment.
